(19) United States
(12) Patent Application Publication
(10) Pub. No.: US 2020/0367537 A1
(43) Pub. Date: Nov. 26, 2020

(54) AGENTS FOR REDUCING METAL CONTENT IN FOOD PRODUCTS AND METHODS RELATED THERETO

(71) Applicant: Axiom Foods, Inc., Los Angeles, CA (US)

(72) Inventor: Robert E. Cadwalader, Glen Ellyn, IL (US)

(21) Appl. No.: 16/989,592

(22) Filed: Aug. 10, 2020

Related U.S. Application Data
(63) Continuation of application No. PCT/US2019/018043, filed on Feb. 14, 2019.
(60) Provisional application No. 62/633,369, filed on Feb. 21, 2018.
(60) Provisional application No. 62/710,376, filed on Feb. 16, 2018.

(51) Int. Cl. A23L 5/20; A23L 33/185

(52) U.S. Cl. CPC A23L 5/273; A23L 33/185

(57) ABSTRACT

Some embodiments relate to metal binding agents and chelators for preparing food products (including nutritional supplements) from vegetable and plant sources for the reduction of heavy metal content. In some embodiments, the plant sources include rice. In some embodiments, when bound or complexed to a metal to be removed, the metal binding agents and chelators are can be separated (e.g., filtered, etc.) from the food material during processing. In some embodiments, the metal binding agents and chelators are organic certifiable.

### CROSS-REFERENCE TO RELATED APPLICATIONS

This patent application is a continuation of International PCT Application No. PCT/US2019/018043, filed Feb. 14, 2019, which claims the benefit of priority to U.S. Provisional Patent Application No. 62/710,376, filed Feb. 16, 2018, and to U.S. Provisional Patent Application No. 62/633,369, filed Feb. 21, 2018. The foregoing applications are fully incorporated herein by reference in their entireties for all purposes.

### BACKGROUND

### Field

Disclosed herein are absorbing agents and chelators for removing metals from food products and methods of use thereof.

### Description of the Related Art

When concentrating and isolating vegetable and plant products, large bulk amounts of material are often isolated and concentrated to afford final products. During this isolation process, heavy metals present in only small amounts of the bulk source can become more concentrated and can reach unacceptably high concentrations.

### SUMMARY

Some embodiments, pertain to a method for preparing an organic and non-organic food product with reduced heavy metal. Any of the methods described above, or described elsewhere herein, can include one or more of the following features.

In some embodiments, the method comprises adding binding or absorbing agent(s) to water to prepare a binding agent mix. In some embodiments, the method comprises adding a food product having heavy metals to water to prepare a food product mix. In some embodiments, the binding agent mix and the food product mix are combined to prepare a food product metal reduction mixture. In some embodiments, the method comprises adding an organic certified or organic certifiable binding agent and an organic food product or non-organic food certified binding agent and a non-organic food product that contains a heavy metal to water simultaneously or sequentially to prepare a food product metal reduction mixture. In some embodiments, the food product metal reduction mixture is agitated for a period of time. In some embodiments, the pH of any one of the mixture is adjusted during or prior to agitation. In some embodiments, the temperature of the food product metal reduction mixture held at a specific temperature or changed during the agitation process.

In some embodiments, the method comprises separating the binding agent from the food product. In some embodiments, the method comprises separating the binding agent from the food product by filtering the binding agent away from the food product to prepare the organic food product or the non-organic food product with reduced heavy metal content. In some embodiments, the binding agent is retained on/by the filter as the filter cake or solution/suspension. In some embodiments, the food product is retained on the filter as the filter cake or retained by the filter as a retained solution/suspension. In some embodiments, the filter cake or the retained filter solution is washed to recover additional treated food product or to remove binding agent.

In some embodiments, the food product to be treated is not a whole grain product. In some embodiments, the food product to be treated is food product is a macronutrient isolate. In some embodiments, the food product is a carbohydrate isolate, a fat isolate, or a protein isolate. In some embodiments, the food product to be treated is a macronutrient is derived from a plant. In some embodiments, the food product to be treated is a flour. In some embodiments, the food product to be treated is derived from plant sources such as white rice, brown rice, rice bran, flaxseed, coconut, pumpkin, hemp, pea, chia, lentil, fava, potato, sunflower, quinoa, amaranth, oat, wheat, or combinations thereof. In some embodiments, the food product to be treated is a plant protein.

In some embodiments, the heavy metal is arsenic, cadmium, lead, mercury, or combinations thereof.

In some embodiments, the method further comprises combining a chelator to the organic food product as a solid, liquid, or solution, or to the non-organic food product as a solid, liquid, or solution before, during, or after mixing with the binding agent mixture. In some embodiments, the organic certified or organic certifiable chelator is a peptide chelator, citric acid, or salts thereof or the food grade chelator is a peptide chelator, citric acid, or salts thereof.

In some embodiments, the binding agent and/or chelator is separated by filtration through a filter. In some embodiments, the binding agent is retained on the filter and the food product travels through the filter. In some embodiments, the food product is retained on the filter and the food product passes through the filter.

In some embodiments, the binding agent is one or more of charcoal, an activated carbon, a zeolite, an alginate, and/or a clay.

In some embodiments, the chelator is a peptide chelator, wherein the peptide chelator is prepared by hydrolyzing an organic protein. In some embodiments, the peptide chelator is prepared by enzymatic or chemical hydrolysis of the organic protein. In some embodiments, the non-organic protein is derived from the same plant or animal as the food product. In some embodiments, the chelator is a peptide chelator, wherein the peptide chelator is prepared by hydrolyzing a non-organic protein. In some embodiments, the peptide chelator is prepared by enzymatic or chemical hydrolysis of the non-organic protein. In some embodiments, the non-organic protein is derived from the same plant or animal as the food product.

Some embodiments, pertain to a composition comprising a rice protein isolate comprising a heavy metal bound to one or more of an organic certified or organic certifiable binding agent and/or an organic certified or organic certifiable chelator. In some embodiments, the organic certified or organic certifiable chelator is a peptide chelator or citric acid. Some embodiments, pertain to a composition comprising a rice protein isolate comprising a heavy metal bound to one or more of a non-organic food grade binding agent and/or a non-organic food grade chelator. In some embodiments, the non-organic food grade chelator is a peptide chelator, citric acid and its salts or ethylenediaminetetraacetic acid (EDTA) and its salts. In some embodiments, the binding agent is one or more of charcoal, an activated carbon, a zeolite, an alginate, and/or a clay.

Some embodiments pertain to an intermediate in the production of a nutritional supplement, the intermediate comprising a rice and other plant protein isolates comprising a heavy metal bound to one or more of an organic certified or organic certifiable binding agent and/or an organic certified or organic certifiable chelator or a non-organic food grade or non-organic food grade binding agent and/or a non-organic food grade chelator.

In some embodiments, the method comprises adding an organic certified or organic certifiable chelator to an organic food product that contains a heavy metal or adding a non-organic food grade chelator to food product that contains a heavy metal. In some embodiments, the method comprises allowing the chelator to bind to the heavy metal thereby forming a complex. In some embodiments, the method comprises separating the complex from the food product to prepare the organic food product or the non-organic food grade product with reduced heavy metal content.

In some embodiments, the organic certified or organic certifiable chelator is a peptide chelator, or the non-organic certified food grade chelator is a peptide chelator, citric acid, EDTA (for non-organic food products), or salts thereof. In some embodiments, the food product is a macronutrient isolate. In some embodiments, the macronutrient isolate is a carbohydrate isolate, a fat isolate, or a protein isolate. In some embodiments, the macronutrient is derived from a plant. In some embodiments, the food product is derived from plant sources such as white rice, brown rice, rice bran, flaxseed, coconut, pumpkin, hemp, pea, chia, lentil, fava, potato, sunflower, quinoa, amaranth, oat, wheat, or combinations thereof. In some embodiments, the food product is a plant protein.

In some embodiments, the heavy metal is arsenic, cadmium, lead, mercury, or combinations thereof.

In some embodiments, the separating step is performed by filtration through a filter. In some embodiments, the complex is substantially soluble and travels through the filter. In some embodiments, the separating step is performed by decanting and/or centrifugation.

In some embodiments, the chelator is a peptide chelator, wherein the peptide chelator is prepared by hydrolyzing an organic protein or a non-organic food grade protein. In some embodiments, the peptide chelator is prepared by enzymatic or chemical hydrolysis of the organic protein or the non-organic food grade protein. In some embodiments, the organic protein or the non-organic food grade protein is derived from the same plant or animal as the food product.

Some embodiments pertain to a composition comprising a plant sourced protein isolate. In some embodiments, the plant (e.g., rice) sourced protein isolate comprises a heavy metal bound to an organic certified or organic certifiable chelator or a non-organic food grade chelator. In some embodiments, the organic certified or organic certifiable chelator or the non-organic food grade chelator is a peptide chelator, citric acid, or EDTA (for non-organic food grade products) and salts thereof. In some embodiments, the peptide chelator is a plant sourced protein hydrolysate. In some embodiments, the protein isolate is an intermediate in the production of a nutritional supplement. In some embodiments, the intermediate comprises a plant sourced protein isolate comprising a heavy metal bound to an organic certified or organic certifiable chelator, or a non-organic food grade chelator.

Some embodiments pertain to a method for preparing a peptide chelator. In some embodiments, the method comprises enzymatically or chemically hydrolyzing an organic protein to form an organic peptide chelator. In some embodiments, the method comprises collecting the peptide chelator. In some embodiments, the organic protein or the non-organic food grade protein is hydrolyzed enzymatically using an enzyme.

In some embodiments, the enzyme comprises one or more of an acid endopeptidase, an alkaline endopeptidase, pepsin, papain, carboxypeptidase, trypsin, chymotrypsin, or thermolysin.

In some embodiments, the method comprises fractionating the peptide chelator from the hydrolysate.

Some embodiments pertain to a peptide chelator. In some embodiments, the peptide chelator comprises dominant (e.g., higher than average intensity and/or darker than average) bands from a PAGE gel (and/or peaks from an optical intensity scan of those bands) at molecular weights ranging from about 21 kD to about 19 kD, about 16 kD to about 14 kD, about 13.5 kD to about 12.5 kD, about 11.5 kD to about 10.5 kD, and/or about 4 kD to about 2 kD. In some embodiments, the dominant PAGE bands (and/or peaks taken from the gel scan) of the peptide chelator are at one or more of about 20.5 kD, about 15 kD, and/or about 12.7 kD. In some embodiments, the dominant bands and/or peaks of the peptide chelators are at one or more of about 20.5 kD, about 15 kD, about 12.7 kD, and/or about 11 kD.

Some embodiments, pertain to a method of making a peptide chelator. In some embodiments, the method includes a step of exposing a protein from a plant source to hydrolytic conditions for a period of time to prepare the protein chelator. In some embodiments, the method includes a step of removing the protein chelator from the hydrolytic conditions. In some embodiments, the method includes a step of collecting the protein chelator.

In some embodiments, the period of time is less than or equal to about 1 hour, about 2 hours, about 4 hours, about 6 hours, or ranges including and/or spanning the aforementioned values.

In some embodiments, during exposure to the hydrolytic conditions, the protein is exposed to an enzyme.

In some embodiments, during collecting of the peptide chelator, the peptide chelator is filtered to isolate the peptide chelator based on size and/or molecular weight.

In some embodiments, the peptide chelator prepared by the methods disclosed herein has dominant bands (e.g., peaks) from a PAGE gel at molecular weight ranges from about 21 kD to about 19 kD, about 16 kD to about 14 kD, about 13.5 kD to about 12.5 kD, about 11.5 kD to about 10.5 kD, and/or about 4 kD to about 2 kD. In some embodiments, the peptide chelator prepared by the methods disclosed herein has its dominant PAGE bands and/or peaks at one or more of about 20.5 kD, about 15 kD, and/or about 12.7 kD. In some embodiments, the peptide chelator prepared by the methods disclosed herein has its dominant PAGE bands (e.g., peaks) at one or more of about 20.5 kD, about 15 kD, about 12.7 kD, and/or about 11 kD.

Some embodiments pertain to peptide chelator, comprising a protein hydrolysate comprising one or more peptides that range in molecular weight from about 2 kD to about 25 kD. In some embodiments, the one or more peptides have molecular weight ranges selected from about 21 kD to about 19 kD, about 16 kD to about 14 kD, about 13.5 kD to about 12.5 kD, about 11.5 kD to about 10.5 kD, and/or about 4 kD to about 2 kD. In some embodiments, the one or more peptides comprise molecular weights selected from about 20.5 kD, about 15 kD, and about 12.7 kD. In some embodiments, the one or more peptides comprise molecular weights selected from about 20.5 kD, about 15 kD, about 12.7 kD, and about 11 kD.

Some embodiments pertain to a peptide chelator made by a method comprising exposing a protein from a plant source to hydrolytic conditions for a period of time to prepare the protein chelator. In some embodiments, the method comprises removing the protein chelator from the hydrolytic conditions. In some embodiments, the method comprises collecting the protein chelator. In some embodiments, the period of time in hydrolytic conditions is less than or equal to about 1 hour, about 2 hours, about 4 hours, about 6 hours, or ranges including and/or spanning the aforementioned values. In some embodiments, exposure to the hydrolytic conditions, the protein is exposed to an enzyme. In some embodiments, during collecting of the peptide chelator, the peptide chelator is filtered to collect the peptide chelator based on size and/or molecular weight. In some embodiments, the method results in a peptide chelator that comprises one or more peptides having molecular weight ranges selected from about 21 kD to about 19 kD, about 16 kD to about 14 kD, about 13.5 kD to about 12.5 kD, about 11.5 kD to about 10.5 kD, and/or about 4 kD to about 2 kD. In some embodiments, the method results in a peptide chelator that comprises one of more peptides that comprise molecular weights selected from about 20.5 kD, about 15 kD, and/or about 12.7 kD. In some embodiments, the method results in a peptide chelator that comprises one of more peptides that comprise molecular weights selected from about 20.5 kD, about 15 kD, about 12.7 kD, and/or about 11 kD.

### BRIEF DESCRIPTION OF THE DRAWINGS

FIG. 1 depicts data quantifying metal content in a variety of rice types and rice from various sources.

FIG. 2A provides an overview of the total % reduction of heavy metals from protein mixtures at different pH values using a various chelators or water.

FIG. 2B depicts results for the reduction of heavy metals from protein mixtures at pH 3 using various chelators or water.

FIG. 2C depicts results for the reduction of heavy metals from protein mixtures at pH 6 using various chelators or water.

FIG. 2D depicts results for the reduction of heavy metals from protein mixtures at pH 9 using various chelators or water.

FIG. 2E depicts results for the reduction of arsenic from protein mixtures at different pH values using various chelators or water.

FIG. 2F depicts results for the reduction of cadmium from protein mixtures at different pH values using various chelators or water.

FIG. 2G depicts results for the reduction of lead from protein mixtures at different pH values using various chelators or water.

FIG. 2H depicts results for the reduction of mercury from protein mixtures at different pH values using various chelators or water.

FIG. 2I depicts results for the reduction of arsenic from protein mixtures at different pH values using various chelators or water.

FIG. 2J depicts results for the reduction of cadmium from protein mixtures at different pH values using various chelators or water.

FIG. 2K depicts results for the reduction of lead from protein mixtures at different pH values using various chelators or water.

FIG. 2L depicts results for the reduction of mercury from protein mixtures at different pH values using various chelators or water.

FIGS. 3A-3B depict the results of water rinses to remove arsenic from protein mixtures at different pH values.

FIGS. 3C-3D depict the results of water rinses to remove cadmium from protein mixtures at different pH values.

FIGS. 3E-3F depict the results of water rinses to remove mercury from protein mixtures at different pH values.

FIGS. 3G-3H depict the results of water rinses to remove lead from protein mixtures at different pH values.

FIG. 4A is an image of a polyacrylamide gel electrophoresis (“PAGE”) peptide separation gel (coomassie blue-stained).

FIGS. 4B-4F are scans showing the molecular weight distribution of the tracks from the FIG. 4A PAGE gel.

### DETAILED DESCRIPTION

Some embodiments disclosed herein pertain to binding or absorbing agents and/or chelators, methods of making and using absorbing agents and/or chelators, and methods for reducing and/or removing metals from food products using absorbing agents and/or chelators. In some embodiments, “binding agent(s)” and “absorbing agent(s)” are disclosed and used interchangeably herein. In some embodiments, the metals removed or reduced are heavy metals. In some embodiments, the food product from which metals are removed or reduced is plant sourced material such as a grain or vegetable. In some embodiments, the plant source material such as a grain or vegetable is subject to a mechanical processing step prior to treatment with one or more absorbing agents and/or chelators. In some embodiments, the mechanical processing step involves breaking the plant source material such as a grain or vegetable and/or grinding the plant source material such as a grain or vegetable to afford a plant source material such as a grain pre-processed product or vegetable pre-processed product. In some embodiments, after being mechanically processed, the plant source material such as a grain product or vegetable product is a flour (e.g., a grain flour and/or a vegetable flour, respectively). In some embodiments, food products to be treated include one or more of pre-processed product, a flour, carbohydrate-based isolates (including starch, cellulose, bran, fiber, carbohydrates, saccharides, polysaccharides, oligosaccharides, maltodextrin, etc.), protein-based isolates, (including amino acids, peptides, oligopeptides, proteins, etc.), fat-based isolates (e.g., oils, fat, etc.), minerals and/or combinations thereof isolated from a variety of sources. In some embodiments, the food products are those isolated from any plant source. In some embodiments, the food products include plant matter or plant source material derived from rice, rice bran, flaxseed, coconut, pumpkin, hemp, pea, chia, lentil, fava, potato, sunflower, quinoa, amaranth, oat, wheat, and the like. In some embodiments, the food product is a grain flour (e.g., a grain that has been powderized). In some embodiments, the food product is one or more of a rice flour (brown or white rice), rice bran flour, flaxseed flour, coconut flour, pumpkin flour, hemp flour, pea flour, chia flour, lentil flour, fava flour, potato flour, sunflower flour, quinoa flour, amaranth flour, oat flour, wheat flour, or the like. In some embodiments, the rice is a brown rice or a white rice. In some embodiments, the food product is any plant protein containing seeds and/or is the seeds of that plant. In some embodiments, the food product is a grain or vegetable protein isolate, including an isolate from any of the protein sources mentioned elsewhere herein. In some embodiments, food products include matter isolated from plants (e.g., plant matter that is one or more of carbohydrate-based, protein-based, fat-based, and/or mineral containing) and/or animal material (e.g., animal material that is protein-based, fat-based, and/or mineral containing). In some embodiments, the food product is organic (e.g., organic-certified or certifiable under U.S., European, or Japanese organic certification standards). In some embodiments, the food product is a non-organic food grade product. In some embodiments, one or more absorbing agents and/or chelators are used to treat the food product at any step during the preparation of the food product. In some embodiments, the absorbing agent and/or chelator is employed to remove or reduce heavy metals from a food product flour as disclosed elsewhere herein. In some embodiments, one or more of an absorbing agent and/or chelator is employed during the isolation of protein, carbohydrate, or fat from the protein source. In some embodiments, one or more of an absorbing agent and/or a chelator is employed after an isolate (e.g., the protein, carbohydrate, fat, or combinations thereof) has been isolated. For example, products can be submitted to metal reducing conditions for metal remediation. In some embodiments, for example, the flour, protein, fat, or carbohydrate, for example, is reprocessed with one or more of an absorbing agent and/or a chelator to remove metals. In some embodiments, one or more of an absorbing agent and/or a chelator is also organic, organic-certified, and/or organic certifiable (e.g., resulting in an organic food product) and in some embodiments, one or more of an absorbing agent and/or a chelator is non-organic and food grade.

In some embodiments, the metal-reduction processes disclosed herein can be done using any one or more of the absorbing agents and/or chelators disclosed herein (alone or in combination) or with other absorbing agents and/or chelators that accomplish the objective of preparing organic or organic certifiable foods or the non-organic food grade foods with substantially removed or reduced heavy metal content. For example, in some embodiments, an absorbing agent and a chelator are used simultaneously (e.g., together) in a single step during metal reduction from the food product. In some embodiments, multiple absorbing agents and multiple chelators are used simultaneously in a single step during metal reduction from the food product. In some embodiments, various absorbing agents and chelating agents are used in separate metal reducing steps. In some embodiments, one or more absorbing agents are used to reduce metal content from the food product and chelators are not used. In other embodiments, one or more chelators are used to reduce metal content from the food product and absorbing agents are not used. In some embodiments, any one of the steps of the methods disclosed herein can be combined and/or omitted.

Because of potential health risks and/or potential dangers associated with consuming chemically treated food, there is a growing demand for organic food. In the United States, there are currently four different levels or categories for organic labeling: 1) ‘100%’ Organic (all ingredients are produced organically); 2) ‘Organic’ (at least 95% or more of the ingredients are organic); 3) ‘Made With Organic Ingredients’ (contains at least 70% organic ingredients); and 4) ‘Less Than 70% Organic Ingredients’ (where three of the organic ingredients must be listed under the ingredient section of the label). Foods that are organically prepared must be free of artificial food additives, and are often processed with fewer artificial methods, materials and conditions, such as chemical ripening, food irradiation, and genetically modified ingredients. Non-synthetic pesticides (e.g., naturally occurring) or treatments are allowed but synthetic ones generally are not.

While consuming organic processed foods is considered healthier than consuming non-organic processed foods, some processed foods, even if organic, can contain harmful agents. For example, despite potential health benefits of organic processed foods, heavy metals may be present in them (just as in non-organic processed foods). These metals can be naturally present in food or can enter food as a result of human activities (such as industrial and agricultural processes).

While some metals (e.g., calcium, magnesium, sodium, potassium, iron, etc.) are essential to biological functions, including cellular functioning, certain metals have no functional effects in the body and are harmful to it. The metals of particular concern in relation to harmful effects on health are mercury (Hg), lead (Pb), cadmium (Cd), chromium (Cr), tin (Sn), and arsenic (Ar). The toxicity of these metals is in part due to the fact that they accumulate in biological tissues much faster than they are excreted, a process known as bioaccumulation. Bioaccumulation occurs in all living organisms as a result of exposure to metals in food and the environment, including in food animals such as fish and cattle as well as humans. Moreover, these metals can become more concentrated in food stuffs as macronutrient products are isolated from the bulk materials from which they are derived (e.g., carbohydrates, proteins, and/or fats).

As noted above, the concern in relation to the toxicity of certain metals vary depending on the metal. Some metals produce potential effects on the brain and intellectual development of young children (e.g., mercury, lead, etc.). Long-term exposure to certain metals (e.g., lead) can cause damage to the kidneys, reproductive and immune systems in addition to effects on the nervous system. Some metals (e.g., cadmium) are toxic to the kidney, and others (e.g., tin) can cause gastrointestinal irritation and upset. Some metals (e.g., arsenic) are of concern because of they cause cancer. Given the wide spectrum of effects on health and the fact that these toxic metals accumulate in the body, it is important to control levels in foodstuffs in order to protect human health.

Some embodiments disclosed herein pertain to absorbing agents and/or chelators (e.g., chelants) that reduce and/or remove metals from food products. In some embodiments, one or more absorbing agents and/or one or more chelators are added to a solution or mixture of food product. In some embodiments, when mixed with a food product, absorbing agents bind and/or entrap one or more metal ions from the solution or mixture. In some embodiments, the chelators bind to one or more metal ions (forming a complex) in the solution or mixture. In some embodiments, the food product is rinsed from the metal-bound absorbing agent and/or complexes (e.g., where the food product is soluble, substantially soluble, has greater solubility than the metal complexes, and/or is of a smaller particle size than the absorbing agent and/or complex). In some embodiments, the bound absorbing agents and/or complexes that are to be removed from the food product are rinsed from the food product (e.g., where the bound absorbing agents and/or complexes are soluble, substantially soluble, have greater solubility than the food product, and/or are of smaller particle size than the food product). In some embodiments, the complex comprises a flocculent or a floating mass that can be skimmed or decanted from a soluble or insoluble solution or mixture of liquid and food product.

In some embodiments, as disclosed elsewhere herein, absorbing agents are used in addition to or instead of chelators. In some embodiments, absorbing agents are chelators. In some embodiments, the absorbing agents are macromolecular structures and/or materials. In some embodiments, the absorbing agents are porous structures (e.g., microporous structures). In some embodiments, the pores of an absorbing agent accept metal ions from solutions. In some embodiments, absorbing agents can capture a metal, in part, based on the size of the metal ion or metal atom. In some embodiments, the absorbing agents (e.g., absorbers) also binds the metal (e.g., once the metal is in a pore of the absorbing agent and/or is in contact with the absorbing agent). In some embodiments, the absorbers can bind the heavy metal through electrostatic interactions.

In some embodiments, the bound metal particles (e.g., metal adhered to or entrapped by an absorbing agent) and/or metal complexes can be separated from the food with 400 μm to 850 μm sized absorbing agents which are in particle form and, after binding or entrapping the metal, these absorbing agents can be filtered, skimmed, or decanted from the food product. In some embodiments, as disclosed elsewhere herein, the food product is processed (e.g. dry milled, wet milled, broken etc.) to form a particlized food product. Using rice as an example, rice can be wet milled or dry milled to prepare particles. In some embodiment, the particlized product (e.g., rice powder) is then placed in a liquid such as water. In some embodiments, the food product powder is mixed with an absorbing agent. In some embodiments, because the particlized product is of a smaller particle size than the absorbing agent, the absorbing agent can be filtered or sieved away from the food product, leaving a reduced heavy metal food product. In some embodiments, the absorbing agent has an average particle diameter of greater than or equal to about: 50 μm, 100 μm, 150 μm, 250 μm, 500 μm, 1000 μm, 2000 μm, 5000 μm, or ranges including and/or spanning the aforementioned values. In some embodiments, the food product has an average particle diameter and/or molecule size of less than or equal to about: 1000 μm, 500 μm, 250 μm, 100 μm, 50 μm, 25 μm, 10 μm, 5 μm, 1 μm, 0.1 μm, 0.01 μm, 0.001 μm, 0.0001 μm, or ranges including and/or spanning the aforementioned values.

In some embodiments, both the food product and the binding agent are solids. In some embodiments, these solids can be separated from each other as long as they are of sufficiently different size to allow one to be filtered from the other.

In some embodiments, where the bound metal particles and/or complexes are substantially or completely soluble and the food product is substantially insoluble or less soluble than the bound metal particles and/or complexes (e.g., a solid suspended solution as a mixture), the mixture is decanted and the supernatant contains the bound metal particles and/or metal complex while the solid contains a food product with a reduced metal content. In some embodiments, prior to decanting, the mixture is centrifuged to separate the solid and liquid phases. In some embodiments, decanting is performed by pouring, sucking (e.g., by vacuum), or otherwise removing the supernatant from the solid. In some embodiments, the mixture is filtered and the filtrate containing the metal complex is removed from the filter cake, which contains the purified food product. In some embodiments, ultrafiltration, dialysis, or microfiltration methods can be used to remove the filtrate from solids.

In some embodiments, where soluble binding agents and/or chelators are used to capture and bind the heavy and other metals, these agents carry the metals from, for example, a plant sourced material such as grain and/or vegetable product (e.g., protein matrix) through a filtration device which retains the food product. In some embodiments, the filtration device allows the bound metal particles and/or complexes to leave the food product suspension, which can then be isolated. The bound metal particles and/or chelator solubilizes metals and can be flushed out of the matrix using water. In some embodiments, the use of peptides allows heavy metal remediation after a food product is already prepared and/or in process as the metal is bound to the peptide and removal is performed via filtration or decantation during the preparation of an initial processed organic food or non-organic food grade product.

In some embodiments the binding agents and/or chelators disclosed herein are food grade but not organic or organic certifiable. In some embodiments, the binding agents and/or chelators disclosed herein are organic, organic certified and/or organic certifiable, or non-organic food grade. In some embodiments, the organic, organic certified and/or organic certifiable binding agent and/or chelator is a metal chelating agent that is naturally occurring or that is produced using organic certified techniques. In some embodiments, by using an organic binding agent and/or chelator, an organic food product can be isolated from the bulk organic food source. In some embodiments, the organic, organic certified or organic certifiable binding agent and/or chelator is a metal chelating agent that can be isolated from natural sources or that is produced using organic certified techniques. In some embodiments, the binding agent and/or chelator is used to prepare a food product that is organic and/or organic certifiable and that has reduced heavy metal content. In some embodiments, the binding agent and/or chelator is used to prepare an organic protein isolate, starch isolate, or fat isolate. In some embodiments, the binding agent and/or organic chelator is used to prepare an organic protein isolate or other food product that is organic certifiable with reduced metals.

In some embodiments, the methods can be performed using any of the following binding agent and/or chelators (together or separately), other binding agent and/or chelators that accomplish the goal of organic certifiable heavy metal removal, and combinations thereof. In some embodiments, any one of the steps or parameters disclosed below can be combined. In some embodiments, steps can be omitted or combined in any way to achieve chelation of metals in food products to reduce the metal content of those foods.

In some embodiments, the chelator, binding agent, and/or absorber is any material that absorbs and/or attracts positive ions (e.g., metal ions, heavy metal ions, cations, etc.). In some embodiments, the absorbing agent is a cation absorber. In some embodiments, as disclosed elsewhere herein, the absorbing agent is a macromolecular structure and/or material in particle form. In some embodiments, the heavy metal reducing agent (e.g., binding agent) is one or more of charcoal, an activated carbon and/or activated charcoal, a zeolite (e.g., microporous aluminosilcate minerals), an alginate (e.g., calcium alginate, sodium alginate, alginate, etc.), and/or clay (e.g., bentonite, kaolinite, etc.). In some embodiments, any other absorber that exhibits a negative charge to attract the heavy metal cations is used. In some embodiments, binding agents that can be separated from the food product (e.g., flour mixture, protein solution, etc.) using a filtration (e.g., using a filter, a sieve, etc.) are selected.

In some embodiments, binding agents can be selected based in part on their particle sizes. In some embodiments, selecting a binding agent based on particle size allows their separation from the food product (e.g., via filtration, sieving, microfiltration, ultrafiltration, and/or nanofiltration) based on the size difference between the food product and the binding agent. In some embodiments, where a filter or sieve is used retain the bound metal absorber (while allowing the food product to pass through the mesh), a binding agent with an average particle diameter of equal to or at least about: 5000 μm, 1000 μm, 840 μm, 500 μm, 420 μm, 300 μm, 100 μm, 50 μm, 10 μm, 1 μm or ranges including and/or spanning the aforementioned values is selected. In some embodiments, a binding agent that is retained by a sieve having a sieve designation under US standards (US MESH) of equal to or greater than about: 10, 20, 40, 50, 100, 200, 400 or ranges including and/or spanning the aforementioned values is selected.

In some embodiments, the particle size of the food product (e.g., white or brown rice brokens, white or brown rice flour, etc.) is selected to allow it to pass through a filter where the binding agent is retained. In some embodiments, where a filter or sieve is used retain the bound metal absorber (while allowing the food product to pass through the mesh), the food product is processed (e.g., via wet milling, etc.) to an average particle diameter equal to or less than about: 5000 μm, 1000 μm, 840 μm, 500 μm, 420 μm, 300 μm, 100 μm, 50 μm, 10 μm, 1 μm or ranges including and/or spanning the aforementioned values. In some embodiments, the food product is milled (or otherwise processed) to have an average size sufficient to pass through a sieve with a US Mesh designation equal to or less than about: 10, 20, 40, 50, 100, 200, 400 or ranges including and/or spanning the aforementioned values. In some embodiments, the food product is milled (or otherwise processed) to have an average size sufficient to pass through a sieve with a US Mesh designation equal to or less than about: 10, 20, 40, 50, 100, 200, 400 or ranges including and/or spanning the aforementioned values. In some embodiments, the food product is milled (or otherwise processed) to have an average mesh size equal to or less than about: 1, 5, 10, 20, 40, 50, 100, 200, 400 or ranges including and/or spanning the aforementioned values. In some embodiments, multiple filtration steps can be performed. For instance, the filtration can be performed using a coarse filter and successively finer filters to remove large particles first, then successively small particles. In other embodiments, smaller filters can be used first to allow pure food product to be isolated. Then larger filters can be employed to recover food products with different amounts of the binding agent and/or chelator in it.

In some embodiments, where the food product passes through the filter or sieve, the food product can be a coarse or fine powder as long as it is smaller than the absorbing agent particle size. For example, in some embodiments, activated charcoal having a mesh size of 20-40, 12-20, 4-12 is used, the food product can be milled to a smaller particle size (a smaller mesh size as noted above), allowing it to pass through the filter for collection. Alternatively, where the activated carbon is selected to allow it to pass through the filter smaller mesh activated charcoal can be selected and larger food product particle sizes.

In some embodiments, in addition to or instead of one or more binding agents, a chelator is used. In some embodiments, the chelator comprises citric acid or a salt thereof. In some embodiments, the chelator comprises a hydrolytically prepared peptide or oligopeptide (a “peptide chelator”), a mixture thereof, and/or salts thereof. In some embodiments, the chelator can be ethylenediaminetetraacetic acid (EDTA) or salts thereof. In some embodiments, one or more of citric acid, the peptide chelator, and/or the EDTA are used in combination. In some embodiments, the chelator can be attached to a solid support (e.g., a bead or the like) to facilitate its removal from solution by filtration. For example, the following solid supports such as resin beads, glass beads, ceramic and polypropylene column packing units, or other similar kinds of supports can be used. In some embodiments, any of the following are used: magnetic beads are used and can be separated by electromagnetic field; affinity chromatography/batch separation—antibodies/fragments against e.g., the peptide chelator; etc. In some embodiments, where a filter or sieve is used retain the chelator (while allowing the food product to pass through the mesh), a solid support with an average particle diameter of equal to or at least about: 5000 μm, 1000 μm, 840 μm, 500 μm, 420 μm, 300 μm, 100 μm, 50 μm, or ranges including and/or spanning the aforementioned values is selected. In some embodiments, a support is selected that is retained by a sieve having a sieve designation under US standards (US MESH) of equal to or greater than about: 10, 20, 40, 50, 100, 200, or ranges including and/or spanning the aforementioned values is selected.

In some embodiments, the peptide chelator is derived from plant (e.g., grain, vegetable, etc.) peptides produced by enzymatic and/or chemical hydrolysis of the proteins. In some embodiments, the enzyme and chemical hydrolysis process allows the production of an organic chelating agent for the reduction of heavy metals in plant material such as grain and vegetable proteins. In some embodiments, one or more enzymes are used to prepare the peptide chelator. In some embodiments, the enzyme is an endopeptidase. In some embodiments, these enzymes cleave the proteins into peptide fragments selectively between specific amino acid sequences. In some embodiments, one or more acid endopeptidases and/or alkaline endopeptidases are used. In some embodiments, the acid endopeptidase enzymes are used in acidic environments. In some embodiments, the acid endopeptidase enzymes are used in a solution with a pH equal to or less than about: 2, 6.5, or ranges including and/or spanning the aforementioned values. In some embodiments, the acid protease enzymes are selected from one or more of pepsin, papain, carboxypeptidase and the like. In some embodiments, the alkaline endopeptidase enzymes are used in a basic pH solution. In some embodiments, the alkaline endopeptidase enzymes are used in a pH less than or equal to about: 7.0, 12, or ranges including and/or spanning the aforementioned values. In some embodiments, the alkaline endopeptidase enzymes include one or more of trypsin, chymotrypsin, thermolysin, and the like. In some embodiments, the pH of the solution used to prepare the peptide chelator is less than or equal to about: 2, 3, 4, 5, 6, 7, 8, 9, 10, 11, or ranges including and/or spanning the aforementioned values. In some embodiments, the enzyme includes one or more of Alcalase®, or DSM Maxipro BAP™. In some embodiments, these endopeptidase enzyme hydrolysis reactions are performed at temperatures equal to or below about: 4° C. and 80° C., or ranges including and/or spanning the aforementioned values. In some embodiments, the endopeptidase enzyme hydrolysis reaction is performed at a temperature greater than or equal to about 50° C. In some embodiments, the enzymatic hydrolysis reactions are performed at temperatures less than or equal to about: 4° C., 10° C., 20° C., 40° C., 50° C., 60° C., 80° C., 99° C., or ranges including and/or spanning the aforementioned values. In some embodiments, the enzymatic hydrolysis is performed for a period of time is less than or equal to about: 1 hour, about 2 hours, about 4 hours, about 6 hours, about 10 hours, or ranges including and/or spanning the aforementioned values. In some embodiments, the process is then quenched by deactivating the enzyme, for example, by heating the mixture to above about: 60° C., 80° C., 85° C., 90° C., 99° C., or ranges including and/or spanning the aforementioned values.

In some embodiments, one or more of the endopeptidase enzyme(s) is added to a grain protein solution. In some embodiments, the pH is adjusted with an alkali such as sodium or potassium hydroxide, or trisodium phosphate. In some embodiments, the pH is adjusted with an acid such as hydrochloric, citric, or phosphoric acid. In some embodiments, the pH is adjusted depending on the type or specific enzyme(s) used. In some embodiments, the solution of protein and enzyme (and/or another hydrolytic reagent) is agitated a period of time to cleave the peptides from the main grain protein chains. In some embodiments, where an enzyme is used, once a desired peptide chelator profile is achieved, the enzyme is denatured or otherwise deactivated. In some embodiments, for instance, the enzyme milieu is heated to above 85° C. for a period of time to deactivate the enzyme(s).

In some embodiments, peptide chelator is produced from the same food source (e.g., the same type of animal, plant such as grain, and/or vegetable source) as the food product being treated. In some embodiments, peptide chelator is produced from a different food source than the food product being treated.

In some embodiments, the peptide chelator comprises a crude protein hydrolysate, containing e.g, a mixture of peptides, oligopeptides, and/or amino acids. In some embodiments, certain fractions of the crude protein hydrolysate are fractionated and/or separated and/or concentrated prior to use as a peptide chelator, via well-known separation techniques such as those based on molecular weight, charge and/or binding affinity. In some embodiments, metal-binding peptide components of the hydrolysate are enriched by affinity separation techniques (batch-wise or chromatography), in which metals are immobilized on beads or separation media and crude hydrolysate is exposed to the affinity media. Non-binding fractions can be washed out and then the metal-bound fraction can be displaced from the metal by higher affinity binders (counter ions, etc.), collected and/or concentrated prior to use as peptide chelators. In some embodiments, certain fractions of the crude protein hydrolysate are fractionated and/or separated and/or concentrated using one or more of filtration, density centrifugation, etc. In some embodiments, the peptide chelator comprises mixture of peptides, oligopeptides, and/or amino acids used as isolated after a hydrolysis of a protein from a plant source. In some embodiments, the peptide chelator comprises one or more multifunctional acid peptides (e.g., di-carboxylic acids, tri-carboxylic acids, tetra-carboxylic acids, or more) with or without amino acid spacers, or other spacers between the acids. In some embodiments, these multifunctional acids bind metals to form metal complexes. In some embodiments, the peptide chelator comprises one or more multifunctional amine-peptides (e.g., di-carboxylic acids, tri-carboxylic acids, tetra-carboxylic acids, or more) with or without amino acid spacers between the amines. In some embodiments, these multifunctional amines bind metals to form metal complexes. Acid and amine functional groups can come from any amino acid of the natural amino acids which comprise both an acid and an amine terminal end (e.g., alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and/or valine). The binding acid or amine can also result from the side chains of the amino acids, for example: glutamic acid and/or aspartic acid (acids); tryptophan, glutamine, lysine, histidine, asparagine, glutamine, and/or arginine (amines and/or guanidinium). In some embodiments, the peptide chelator comprises one or more thio or hydroxyl substituents that bind to the metal (e.g., serine, threonine, cysteine, methionine, tyrosine).

In some embodiments, the peptide chelators are isolated based on a molecular weight fraction of the hydrolytically treated protein. In some embodiments, the peptide chelators comprise a protein hydrolysate having one or more peptides of different molecular weight. In some embodiments, the protein hydrolysate is a plant protein hydrolysate generated by enzymatic digestion of a plant protein source. In some embodiments, the protein hydrolysate has one or more peptides that range in molecular weight from about 500 kD to about 25,000 kD. In some embodiments, one of more of the peptides is further purified (e.g., by size exclusion and/or ion exchange chromatography) and used as the peptide chelators. In some embodiments, the number average molecular weight (g/mol) and/or weight average molecular weight (g/mol) of the peptide chelator is equal to or less than about 500, 1000, 2000, 5000, 10,000, 15,000, 20,000, 25,000 or ranges including and/or spanning the aforementioned values. In some embodiments, the molecular weight (g/mol) of the peptide chelator is equal to or less than about 500, 1000, 2000, 5000, 10,000, 15,000, 20,000, 25,000 or ranges including and/or spanning the aforementioned values.

In some embodiments, mixtures of these amino acids with their varying functional groups bind to metals to form complexes. In some embodiments, amino acid configurations that result in 5-membered rings or 6-membered rings can provide more favorable binding orientations (e.g., between the thiol, amine, and metal in, for example, serine), but are not required. Such configurations include those including GHK complexes (e.g., binding of a metal by the glycine amine and amide and the imidazole of the histidine). Single amino acids and amino acid chains (e.g., 2, 3, 4, 5, 6, or more in length) can be used as chelating agents.

In some embodiments, other chelating materials can be used in addition to or instead of those described above. In some embodiments, the chelating agents are derived from plant materials, for example, algae, tea saponin, humic acid, potato peels, sawdust, black gram husk, eggshell, coffee husks, sugar beet pectin gels, citrus peels, papaya wood, maize leaf, leaf powder, lalang, leaf powder, rubber leaf powder, peanut hull pellets, sago waste, saltbush leaves, tree fern, neem bark, grape stalk, rice husks, spent grain (e.g., from brewery), sugarcane bagasselfly ash, wheat bran, corncobs, weeds (Imperata cylindrical leaf powder), fruit/vegetable wastes, cassava waste, plant fibres, tree barks, Azolla, alfalfa biomass, cottonseed hulls, soybean hulls, pea hulls, Douglas fir bark, walnut shell, Turkish coffee, nut shell, lignin, sphagnum moss peat, bamboo pulp, orange peel (white inner skin), orange peel (outer skin), senna leaves, and combinations thereof.

In some embodiments, the removal or reduction of metal from the food product is carried out in water (e.g., deionized, RO, soft, or tap water). In some embodiments, one or more binding agents and/or chelating agents and food agent are each added to water. In some embodiments, the food product is added prior to the one or more binding agents and/or chelating agents. In some embodiments, the binding agent and/or chelating agent is added to the water prior to the food product. In some embodiments, the mixture is then agitated for a period of equal to or at least about: 15 minutes, 20 minutes, 60 minutes, 120 minutes, 180 minutes, or ranges including and/or spanning the aforementioned values.

In some embodiments, different weight percent (wt %) values of food product can be added to the water. In some embodiments, the wt % of food product in water is equal to or at least about: 5%, 10%, 25%, 50%, 60%, or ranges including and/or spanning the aforementioned values.

In some embodiments, the amount of binding agent and/or chelator used to treat the food product is based on a dry measurement. For instance, in some embodiments, a 2% dry weight measure of chelator to food product indicates 2 grams of chelator for every 98 grams of food product (2 g chelator/100 g total dry weight). In some embodiments, the dry weight measure of binding agent and/or chelator used to treat the food product is less than or equal to about: 0.5%, 1%, 2%, 5%, 10%, or ranges including and/or spanning the aforementioned values.

In some embodiments, the amount of binding agent and/or chelator (or combinations thereof) used to treat the food product is based on a weight percent measure. For instance, in some embodiments, the treated formula comprises a food product (e.g., a mixture and/or suspension of plant matter, such as, protein, protein isolate, carbohydrate, etc.) in a liquid (e.g., water). In some embodiments, a 2 wt % measure of chelator to formula indicates 2 grams of chelator (e.g., a solute) for every 100 grams of formula (e.g., the food product (e.g., rice flour, etc.), chelator, and liquid solvent). In some embodiments, the wt % of binding agent and/or chelator used to treat the formula is less than or equal to about: 0.0125, 0.25%, 0.5%, 1%, 1.25%, 2%, 5%, 7.5%, 10%, or ranges including and/or spanning the aforementioned values. In some embodiments, the weight percent of dry food product matter in the formula is equal to or greater than about: 10%, 20%, 30%, 40%, 60%, 80%, 90%, 99%, or ranges including and/or spanning the aforementioned values.

In some embodiments, a chelator is not used and, instead, a liquid without or substantially without an added chelator is used instead to remove metal from the food product. For example, in some embodiments, one or more combinations of liquids such as water, ethanol, etc. are used to remove the metal.

In some embodiments, metal removal and/or reduction can be performed at different pH values. In some embodiments, varying the pH of the solution in which the binding and/or chelation and/or filtration takes place increases the solubility of, for example, the metal ions, the metal complex (where present), and/or the metal allowing it to be removed from, for instance, the food product. In some embodiments, for example, where the binding agent and/or complex (where present) or metal is more insoluble than the food product, the food product's solubility can be increased by varying the pH of the solution which it is in. In some embodiments, the pH of the solution used to perform the binding, complexation, and/or metal removal or reduction is less than or equal to about 2, 2.5, 3, 4, 5, 6, 7, 8, 9, 10, 11, or ranges including and/or spanning the aforementioned values.

In some embodiments, the pH can be changed to enhance the solubility of the heavy metal entities. For instance, lead is more soluble in the higher pH range while the cadmium and arsenic are more soluble in the lower pH range. In some embodiments, high protein yields can be achieved at the isoelectric point of the plant material being processed. In some embodiments, however, the isoelectric point of the food product may not be optimal for heavy metals removal. In some embodiments, the pH of the solution can be changed (e.g., raised or lowered) at one or more different steps and/or times to achieve removal of different metals and/or to increase the yield of the food product. For example, in some embodiments, a lower pH can be used to increase the binding of cadmium and arsenic. Then, the pH could be raised to facilitate removal of lead. The use of binding agents is especially effective under these variable pH conditions because, for example, once inside a pore of the binding agent, the metal does not substantially escape the binding agent, even if the metal is no longer highly soluble in the outer solution.

In some embodiments, organic certified and/or food grade acids and bases are used to change the pH of the water mixture. In some embodiments, food grade acids and bases are used to change the pH of the water mixture.

In some embodiments, metal removal and/or reduction can be performed using methods at different solution temperatures. In some embodiments, the water is held at a temperature during mixing of the food product with the one or more binding agents and/or chelating agents. In some embodiments, the water is a temperature of equal to or less than about: 5° C., 15° C., 25° C., 45° C., 75° C., 85° C., 95° C., 99° C., or ranges including and/or spanning the aforementioned values. In some embodiments, temperatures below about 23° C. are used to avoid certain plant material such as grain starch blooming or swelling (e.g., rice starch blooming). In some embodiments, higher temperatures are used to facilitate filtering. In some embodiments, varying the temperature of the solution in which the chelation (where performed), metal dissolution, and or filtration takes place increases the solubility of, for example, the metal complex (where present) or metal allowing it to be removed from, for instance, a suspended food product (e.g., where the metal complex is soluble and the food product is not). In other embodiments, for example, where the complex (where present) or metal is more insoluble than the food product, the food product's solubility can be increased by varying the temperature. In some embodiments, the temperature of the solution used to perform the complexation and/or metal reduction is less than or at equal to about 4° C., 10° C., 20° C., 40° C., 60° C., 80° C., 99° C., or ranges including and/or spanning the aforementioned values.

In some embodiments, filtration (and/or sieving), microfiltration, ultrafiltration, and/or nanofiltration membrane technologies are used to retain the bound metal absorber and/or chelating agent(s) and/or other impurities while allowing the food product (e.g., grain and/or vegetable protein) to pass the resulting in reduction of heavy metals the food product. In some embodiments, the filtration is performed with a sieve or filter having opening sizes of equal to or less than about: 5000 μm, 1000 μm, 840 μm, 500 μm, 420 μm, 300 μm, 100 μm, 50 μm, 10 μm, 1 μm, 0.1 μm. 0.01 μm or ranges including and/or spanning the aforementioned values. In some embodiments, sieving is performed with a sieve having a sieve designation under US standards of equal to or less than about: 10, 20, 40, 50, 100, 200, 400 or ranges including and/or spanning the aforementioned values. In some embodiments, the filtration is performed with a microfiltration membrane having a molecular weight cutoff (in Daltons) of equal to or less than about: 10,000, 100,000, 200,000, 500,000, 1,000,000, or ranges including and/or spanning the aforementioned values. In some embodiments, the filtration is performed with a microfiltration membrane having a pore size equal to or less than 0.1 μm, 0.5 μm, 0.8 μm, 1.0 μm, 1.2 μm, 1.4 μm, 2.0 μm, or ranges including/or spanning the aforementioned values. In some embodiments, a microfiltration membrane with a molecular weight cutoff of about 100,000 Daltons to 4 microns is used. In some embodiments, the filtration is performed with an ultrafiltration membrane having a molecular weight cutoff (in Daltons) of equal to or less than about: 700, 10,000, 50,000, 100,000, 500,000, 800,000, or ranges including and/or spanning the aforementioned values. In some embodiments, the filtration is performed with a nanofiltration membrane having a molecular weight cutoff (in Daltons) of equal to or less than about: 100, 300, 500, 1,000, or ranges including and/or spanning the aforementioned values. In some embodiments, the microfiltration, ultrafiltration, and/or nanofiltration membranes are composed of inorganic and/or organic substrates. In some embodiments, the microfiltration, ultrafiltration, and nanofiltration membrane modules can be composed of spiral, hollow fiber, plate and frame, tubular, and/or extruded membrane configurations.

In some embodiments, the binding agent and/or chelator left on the filter or sieve after filtration (e.g., the filter cake) can be washed with one or more water washes (e.g., 1, 2, 3, 4, or more) to recover additional food product. In some embodiments, the wash volume is a smaller volume than used during the initial metal removal step to avoid potential recontamination of metal into the food product. In some embodiments, the wash volume is less than the treatment volume by about: 50%, 80%, 90%, or ranges including and/or spanning the aforementioned values.

In some embodiments, binding agent is remove by the filter step leaving the filtrate and food product. In some embodiments, the food product is then filtered from the filtrate using a finer filter. In some embodiments, the binding agent can be washed again with the filtrate. In some embodiments, any of the above steps or any of the steps disclosed elsewhere herein can be performed continuously (a continuous process) or as a batch process.

In some embodiments, a suspension and/or solution of the binding agent and/or chelating agent is prepared. In some embodiments, a suspension or solution of the food product is prepared. In some embodiments, these solutions and/or suspensions are mixed to provide the metal removing solution. In other embodiments, dry binding agent and/or chelating agent can be added a solution and/or suspension of food product. In other embodiments, dry food product can be added a solution and/or suspension of binding agent and/or chelating agent.

In some embodiments, microfiltration, ultrafiltration, and/or nanofiltration membrane technologies are used to retain the target food product (e.g., grain and/or vegetable protein) while allowing chelating agent(s) and/or other impurities to pass the membranes resulting in reduction of heavy metals the food product. In some embodiments, the filtration is performed with an ultrafiltration membrane having a molecular weight cutoff (in Daltons) of equal to or less than about: 1,000, 10,000, 100,000, 200,000, 500,000, 1,000,000, or ranges including and/or spanning the aforementioned values. In some embodiments, the filtration is performed with a microfiltration membrane having a pore size equal to or less than 0.1 μm, 0.5 μm, 0.8 μm, 1.0 μm, 1.2 μm, 1.4 μm, 2.0 μm, or ranges including/or spanning the aforementioned values. In some embodiments, a microfiltration membrane with a molecular weight cutoff of about 100,000 Daltons to 4 microns is used. In some embodiments, the filtration is performed with an ultrafiltration membrane having a molecular weight cutoff (in Daltons) of equal to or less than about: 700, 10,000, 50,000, 100,000, 500,000, 800,000, or ranges including and/or spanning the aforementioned values. In some embodiments, the filtration is performed with a nanofiltration membrane having a molecular weight cutoff (in Daltons) of equal to or less than about: 100, 300, 500, 1,000, or ranges including and/or spanning the aforementioned values. In some embodiments, the microfiltration, ultrafiltration, and/or nanofiltration membranes are composed of inorganic and/or organic substrates. In some embodiments, the microfiltration, ultrafiltration, and nanofiltration membrane modules can be composed of spiral, hollow fiber, plate and frame, tubular, and/or extruded membrane configurations.

In some embodiments, the heavy metal removal and/or reduction process is performed in vessels with agitation. In some embodiments, the heavy metal removal and/or reduction process is performed in a packed column containing the absorbing agent. In some embodiments, the slurry of food product, metals, and water is rinsed though the packed column. In some embodiments, the solution is passed in plug flow condition (with plug flow meaning low flow conditions that minimize turbulence to thus minimize back mixing providing a more accurate means of achieving a set solution residence time in a column or pipe.

In some embodiments, as disclosed elsewhere herein, prior to treatment with a binding agent and/or chelator, the food product is steeped in hot water and wet milled. In some embodiments, for example, a whole grain brown or white rice and/or white rice brokens can be processed by steeping in hot water and then wet milling to particle sizes smaller than the absorber particle size. In some embodiments, the wet milled solution can be processed at the milled temperature (e.g., a temperature of equal to or less than about: 5° C., 15° C., 25° C., 45° C., 75° C., 85° C., 95° C., 99° C., or ranges including and/or spanning the aforementioned values), or the solution at milled temperature can be heated or chilled and the wet milled solution can be further processed enzymatically or chemically before the absorber is added. In some embodiments, the pH can also be changed disclosed elsewhere herein. [0092] Some embodiments involve the use of fabric and/or screen filter technologies to retain the target grain and/or vegetable products (e.g., proteins) while allowing chelating agent(s) and/or other impurities to pass the membranes resulting in reduction of heavy metals. In some embodiments, the fabric can be of any natural or manmade woven or extruded material. In some embodiments, the screen can be of any metallic or plastic material. In some embodiments, the screen can have a mesh opening equal to or less than about: 10 mesh, 100 mesh, 400 mesh, or ranges including and/or spanning the aforementioned values. In some embodiments, the filter system uses a fabric and/or screen mesh, and/or sintered stainless steel, ceramic, or glass filter. In some embodiments, as disclosed elsewhere herein, the food product can be processed to a size small enough to pass through the fabric or filter while the binding agent is retained in the filter.

In some embodiments, the filtration system is in a configuration of a cartridge filter, plate and frame filter, dual continuous belt filter, vacuum drum filter, flat plane filter, inclined filter, or incrementing belt filter.

In some embodiments, the filtration process is performed using a solution at a temperature less than or equal to about 4° C., 10° C., 20° C., 40° C., 60° C., 80° C., 99° C., or ranges including and/or spanning the aforementioned values. In some embodiments, the membrane system operating pressure is performed at a pressure of equal to or at least about: 1 bar, 10 bars, 20 bars, 50 bars, or ranges including and/or spanning the aforementioned values. In some embodiments, the membrane system operating pressure is as required by the system and the membrane type and composition. In some embodiments, the fabric and/or screen filter system operating pressure can be operated at a vacuum (e.g., on the filtrate side of the filter).

In some embodiments, the filtration step and membrane system uses water devoid of or substantially devoid of heavy metals. In some embodiments, the filtration process can rinse a variable volume of water through the membrane removing the heavy metal chelating complex until the desired level of heavy metal remains in the food product (e.g., the protein matrix). In some embodiments, the water can be employed at any pH desirable in the range stated above and can also be varied from the beginning of filtration until filtration is complete. In some embodiments, the filtration water can be employed at any temperature desirable in the range stated above and can also be varied from the beginning of filtration until filtration is complete. In some embodiments multiple filtration stages can be used in a continuous process flow and a different pH and/or chelant can be used in each stage. In some embodiments a multiple stage continuous filtration process can be used where in the filtrate from the last stage can be used as the rinse to the previous stage in a counter flow fashion from last stage to any previous stage in the multi-stage filter system. In some embodiments, the operating pressure can be varied as desired at any time during the filtration process in the range stated above.

In some embodiments, rinses having a pH different than the initial metal binding and/or chelating solution can be used to rinse bound binding agent and/or metal complexes from the food product (e.g., flour, grain and vegetable proteins, etc.). These varying pH values, as disclosed elsewhere herein, can be used for any of the disclosed filtration techniques (e.g., using sieves or filters, using microfiltration, ultrafiltration, nanofiltration membrane technologies, or fabrics) to allow retention of the material to be removed, while allowing the altered pH water to pass. In some embodiments, liquid rinses at various pH levels can be mixed or matched to remove various metals (or complexes) that may have solubilities that vary with pH.

In some embodiments, filtration is not used and the soluble fraction (or smaller particle fraction) of a mixture is removed by decanting (e.g., using a centrifugal decanter). In some embodiments, a centrifuge can be used to separate the insoluble fraction (or smaller particle fraction) from the solution. In some embodiments, a stacked disc centrifuge and/or a centrifugal basket centrifuge can be used to separate the insoluble fraction from the solution (supernatant). In some embodiments, the supernatant is poured, pumped, or sucked away with a vacuum from the solid fraction. In some embodiments, the centrifuge decanter can be placed in a continuous staged operation. In some embodiments, the supernatants from the centrifuge decanter can be counter-flowed as rinse water to the previous centrifuge decanter in the staged operation.

In some embodiments, the metals removed by the processes disclosed herein include metals having an atomic weight that is greater than or equal to about: 63.5, 100, 200.6, 600, 700, or ranges including and/or spanning the aforementioned values. In some embodiments, the metals removed and/or reduced include one or more of arsenic, zinc, copper, nickel, mercury, cadmium, lead, selenium, and chromium. In some embodiments, the chelating agents bind to, remove, and/or reduce metals having a specific gravity of greater than about: 3.0, 5.0, 10.0, or ranges including and/or spanning the aforementioned values.

In some embodiments, the chelators (or methods) disclosed herein allow a reduction in the amount (e.g., the weight or molar content) of one or more of metals (e.g., Hg, Pb, Cd, Cr, Sn, Ar) by at least about: 50%, 75%, 90%, 99%, 99.9%, or ranges including and/or spanning the aforementioned values. In some embodiments, the chelators (or methods) disclosed herein reduce the amount of one or more of the metals in the food product to equal to or less than about: 10 ppm, 1 ppm, 100 ppb, 1 ppb, or ranges including and/or spanning the aforementioned values. In some embodiments, the metals are reduced to levels found acceptable for consumption by the FDA and/or the European Food Safety Authority. In some embodiments, for example, Ar is reduced to equal or less than about 125 ppb, Cd is reduced to equal or less than 250 ppb, Pb is reduced to equal or less than about 125 ppb, Hg is reduced to equal or less than about 29 ppb.

The methods disclosed herein can be used for preparing any of the food products mentioned elsewhere herein, including, for example, rice flour, maltodextrin, and rice protein from rice (e.g., white rice, brown rice, etc.) and rice brokens (e.g., rice grain that is broken and not whole and which is usually damaged during the bran removal step which is a mechanical abrasion of the rice grain) with reduced heavy metal content or with heavy metals substantially and/or completely removed. In some embodiments, metal chelators can be introduced during the production of a plant-derived food products to remove metals. In some embodiments, methods for removing metals by using washes at particular stages during the rice product preparation are used. In some embodiments, based on the techniques used to remove these metals, the products disclosed herein are hypoallergenic and can retain their “organic food” status.

### EXAMPLES

### Example 1

### Rice Testing

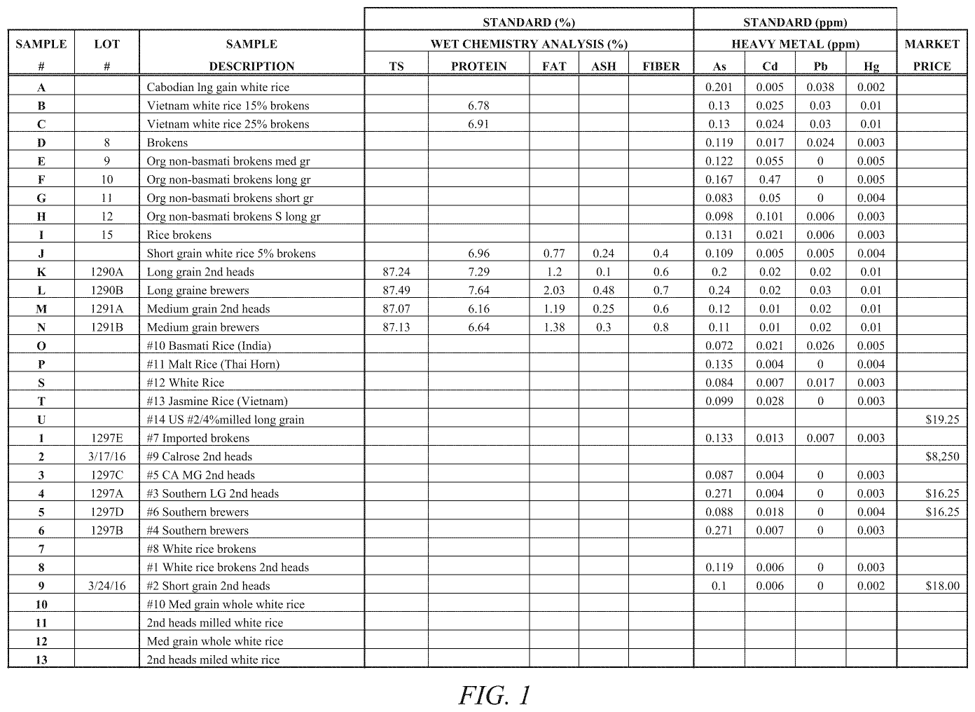

To determine the amount of As, Cd, Pb, and Hg in a variety of rice sources, testing was performed. The testing results are shown in FIG. 1. Briefly, the amount of the heavy metals in several rice sources (e.g., from different countries, species of rice, suppliers, etc.) was measured by atomic absorption spectroscopy (ICP-MS) (method reference number AOAC: 993.14). Additionally, as shown in FIG. 1, other components characterized in the test samples were moisture and total solids (see, e.g., Samples B, C, and K-N) (forced air oven 130° C.) (by reference method AOAC: 926.07, 925.10, 934.06, 969.38, 977.21, AACC: 44.15 44.3), as well as the total protein (Dumas) (by reference method AOAC: 992.15, AACC: 46-30), fat (gravimetric) (by reference method AOAC: 948.15, 922.06, 925.32, 950.54, 922.09), ash (overnight) (by reference method AOAC: 923.03), and fiber content of certain rice samples (e.g., Samples B, C, and K-N). All of these measurements were performed by an independent analytical laboratory using the noted referenced methods.

For the metal reduction trials performed, a sample of rice protein isolate with elevated heavy metals was used to obtain data and validate the ability of these techniques to reduce the heavy metal content in the final treated and dried protein powder. All samples were corrected to the same total solids content. Because the heavy metal content is measured as parts per billion (ppb) of the total weight of the sample and because the dried samples can contain varying amounts of moisture, to make sure all values are comparable the samples were corrected to bone dry basis. An example of how this is done is explained below in the next paragraph.

Assume powder or rice sample #1 contains 10% moisture (90% powder) and measures 1000 ppb of heavy metal M⁺⁺. Assume powder or rice sample #2 contains 13% moisture (87% powder) and measures also 1000 ppb of heavy metal M⁺⁺. If sample #1 is corrected to a bone dry basis the heavy metal content will be corrected by multiplying the 1000 ppb by 100%/90%=1.111 and the corrected heavy metal content will be 1000 ppb×1.111=1111 ppb. If sample #2 is corrected to a bone dry basis the heavy metal content will be corrected by multiplying the 1000 ppb by 100%/87%=1.149 and the corrected heavy metal content will be 1000 ppb×1.149=1149 ppb. It can be seen that before correction the conclusion would be that both samples contain the same amount of heavy metal when in actuality there is a 38 ppb difference.

This information was used to measure the amount of heavy metals in the target rice protein isolate as the basis for the removal protocol then measure and compare the effects of each chelation and wash protocol on the reduction of the heavy metal measured in the treatment of the starting rice protein isolate with the different chelation and wash protocol.

The following table shows the average amount of each As, Cd, Pb, and Hg present (in ppm) in the random rice samples separated by the country/region of origin.

TABLE 1

| AVERAGE HEAVY METAL RESULTS (ppm) | | | | |
|---|---|---|---|---|
| As | Cd | Pb | Hg | |
| 0.13676 | 0.03804 | 0.01116 | 0.005 | average all |
| 0.1285 | 0.008357 | 0.008 | 0.004643 | average American |
| 0.115714 | 0.059571 | 0.011929 | 0.004286 | average Asian |

As shown, of the rice samples tested, on average the American sources appeared to have higher levels of As and Hg, while the Asian sources appeared to have higher levels of Cd and Pb. Based on the techniques developed for reducing metals described herein, subjecting particular rice sources to tailored chelating techniques for particular metals and/or combinations of chelation techniques could remove and/or reduce metal levels to suitable levels while producing a food that retains an “organic food” designation.

### Example 2

Comparison of Various Chelating Agents and/or Methods for Removing Metals

The experiments disclosed herein were performed using chelating compounds (including rice-based peptide chelators, citric acid, EDTA, etc.). The heavy metal content in rice and rice extract products (e.g., protein) was tested. It was determined that heavy metals found naturally in rice can be bound by organometallic coordination to chelators (e.g., rice protein peptides) to remove and/or reduce heavy metals from, for example, protein extract fractions of plant-derived food products. In some embodiments, washes (e.g., water washes) performed during the preparation of the rice product can be used to remove heavy metals from plant-derived food products. In some embodiments, the washes performed during the preparation can be performed at various pH levels to remove certain heavy metals from plant-derived food products. In some embodiments, the use of these chelators (and/or wash methods) can be performed in a GRAS (“generally recognized as safe”) and “organic” compliant way to reduce and/or substantially remove metals from a food product. In some embodiments, the chelators and wash methods disclosed herein can be used to prepare organic products. In some embodiments, water washes alone performed during the preparation of the product remove heavy metals.

### Testing Overview

The capacity for rice-based peptide chelators, citric acid, and EDTA to remove metals from rice products was measured as was the ability of rinse solutions during the preparation of protein products. The metal levels of the protein product prior to treatment and after exposure to the chelator (and or the wash solution) were measured. To test the ability of chelators (rice-based peptide chelators, citric acid, and EDTA) to remove heavy metals, a rice protein product with elevated levels of heavy metals and at various pH values was exposed to each chelator separately. The solution was then rinsed via centrifugation to remove the chelator and heavy metals. Where chelator-free washes were used, the pH was varied without the addition of a chelant.

### Experimental Procedures

The rice-based protein chelator (e.g., the peptide chelant) was prepared by hydrolyzing a Silk 80 AXIOM product. Axiom's Silk 80 product is a rice protein isolate produced from whole and/or broken white rice grains. Rice grain is normally about 7% protein and 89% starch and the Silk 80 product is protein that has been removed from the grain and purified to high levels of protein content. The protein isolate is generally 75% to 96% protein purity on a dry weight basis. It is manufactured by converting the starch portion via enzymatic action into lower molecular weight carbohydrate fractions and then removing the lower molecular weight carbohydrate fractions via filtration, decantation, or centrifugation to reduce the carbohydrate, ash, and fat content relative to the protein in the final isolate. Briefly, a rice-based peptide chelator was prepared by the following procedures. 100 g of Silk-80 (AXIOM protein product: Moisture: 2.7%; Protein 81%; Fat 1.2%; Ash <4.5%, Fiber: <10%, Carbohydrate <13.3%) was placed into agitator and agitated with 233 g of hot 50° C. RO/DI water producing 300 g of solution (˜30% total solids). To this solution was added 3.6 g (300 ppm) CaCl₂. To this solution was added 10% NaOH to bring pH to 8.5 (+/−0.1). To this mixture was added Alcalase® (an alkaline protease enzyme) at 2% by weight of the protein dry weight. The solution was agitated at 50° C. for 4 hours. After 4 hours, the mixture was heated to 80-85° C. and held for 10 minutes to deactivate the enzyme. After 10-minute hold time the mixture was cooled to 50° C., the mixture was then centrifuged causing the solids to separate via G-forces from the peptide solution. The supernatant containing the peptide chelators was decanted and the weight of total solids was measured. The supernatant was collected for use as a chelator. A dilute solution of peptides was obtained from this enzyme hydrolysis of rice protein. This product was filtered and stored for use during chelation experiments.

Food grade Citric acid chelant was used as purchased from Hawkins chemical supply company. Food grade EDTA chelant was used as purchased from Santa Cruze Biotechnology, Inc.

After the chelators were prepared and/or purchased, a rice protein isolate product with elevated levels of heavy metals was exposed to each chelator separately as a mixture and then the chelators were rinsed from the protein product via washing and recovery of the protein by application of a centrifuge.

For each of the tests below, a bulk solution of protein was prepared from a rice protein isolate powder (Moisture: 4%; Protein (purity): 80.7%; Fat: 3.4%; Ash: <4.5%; Fiber: <10%; Carbohydrates: <11.4%; Heavy Metals (analyzed in triplicate): Arsenic (range 88-114 ppb): 101 ppb used; Cadmium: (range 1199-1418 ppb): 1199 ppb used; Lead (range 240-310 ppb): 310 ppb used; Mercury (range 23.4-29.5 ppb) 29.5 ppb used).

In general for the test, a chelant (or no chelant) was added, the pH was adjusted, and the treated protein was agitated with the chelant solution and then isolated, and the content of heavy metals was tested. Briefly, for a particular chelant, a 480 g of deionized water was heated to 50-70° C. and agitated. To the water was added 120 mL of starting rice protein solution (a protein mixture having protein contaminated with higher than normal and various amounts of different heavy metals). From this 600 mL solution was taken three 200 g aliquots. The pH of the first solution was adjusted to pH of 3 using a solution of 10% by weight HCl (e.g., concentrated 38% HCl diluted to 10% by weight with water). The pH of the second solution was adjusted to pH 6 using a solution of 10% by weight HCl. The pH of the third solution was adjusted to pH 9 using a solution of 10% by weight of concentrated 50% NaOH. These procedures were performed for each chelant at three different pH values (e.g., pH 3.0, pH 6.0, and pH 9.0). The pH was measured with a temperature correcting pH meter. Each solution was agitated for 15 minutes at a temperature of 70° C.

To achieve the chelant heavy metal reduction, to the pH adjusted protein solutions described above was added enough chelant (peptide chelant, citric acid, EDTA) to afford a solution that is 2% weight of the chelant relative to the dry weight protein content (e.g., 2 g chelant relative to 100 g of dry plant protein). The mixtures were agitated for 15 minutes at a temperature of 70° C. at which time the solid fractions were separated by centrifugation. To achieve isolation of the solid protein fraction, samples were centrifuged at 9,000 RPM using a Perkin Elmer centrifuge. After 3 minutes of centrifuging, the supernatant was decanted off with a vacuum pipet. The rinse process was repeated 3 times (a 4× rinse by weight) by adding 120 mL of water at a temperature of 70° C., centrifuging, and decanting off the supernatant. The centrifugation and decanting steps can be repeated until the desired amount of rinsing is achieved. More or less centrifugation/rinse steps could be performed depending on the final amount of heavy metals desired in the final plant protein product. The final decanted protein solids were placed into a container, frozen, shipped overnight via carrier to a selected independent analytical laboratory, and analyzed for heavy metals and solids. The heavy metal content of the resultant protein solids fraction was then determined using atomic absorption spectroscopy. The supernatant solutions were also collected and frozen for analysis.

To test the ability of water at an elevated temperature (e.g., at a temperature of 70° C.) to remove heavy metals from plant protein, the rice protein product having elevated levels of heavy metals was prepared at pH values of 3, 6, and 9 as described above. The same procedures were performed as with the chelant except that no chelating agent was added to the protein fraction. The pH adjusted water and plant protein mixture was agitated and the resulting mixture was put through the identical centrifugation and washing cycles as was used as described above for the chelant containing mixtures. In some embodiments, the reduction of certain heavy metals from the food product can be achieved using water washes with water at a temperature of at least about: 5° C., 10° C., 30° C., 50° C., 70° C., 90° C., 95° C., or ranges including and/or spanning the aforementioned values. In some embodiments, the reduction of certain heavy metals from the food product can be achieved using water washes with water that has been pH adjusted to 2.0, 3.0, 4.0, 5.0, 6.0, 7.0, 8.0, 9.0, 10.0, 11.0, 12.0, or ranges including and/or spanning the aforementioned values.

### Results

All total solids were normalized with the respective HM data to ensure accurate analysis and conclusions from the test work as the dry solids have relatively no water to dilute the heavy metal content whereas when the protein is placed in a water mixture the heavy metals are diluted by the water and are measured on a total mass basis which includes the water. This will give a much lower level of heavy metals than exists on a dry weight basis so the results are corrected to a common solids concentration where the process was started and the amounts of heavy metals compared to the concentrations measured in the original starting solution solids concentration. This provides a more accurate comparison of the pre and post treatment heavy metal content of the protein mixture. Not all samples were exactly the same solids concentrations. For that reason, because a target initial solution of 30% total solids was desired, all values were corrected to the 30% solids value making the measured heavy metal results directly comparable to each other. The following paragraph provides a demonstrative theoretical calculation.

Starting heavy metal powder on a bone dry basis has 1000 ppb of a heavy metal M⁺⁺. To make an arbitrary 100 g starting solution of 30% total solids 30 grams of bone dry powder will be mixed with 70 g of water. When analyzed this sample will now have a content of 300 ppb of heavy metal M⁺⁺ Even though nothing has been done to the sample except dilute it to a 30% solution with water the heavy metal content of this liquid sample will not test out at 1000 ppm anymore. After processing, getting the filtration system to provide a final liquid protein sample at 30% is very difficult and drying the sample before analysis is not feasible. The resulting final liquid sample solids will need to be adjusted to the original target 30% to get a proper comparison to the starting material. To accomplish this correction let us say that the liquid sample coming from the separation system is 28% and at 28% the heavy metal concentration is measured at 150 ppb. This 150 ppb measurement is lower than the actual separation provided because of the slight dilution at 28%. So this liquid sample result of 150 ppb is corrected to 30% by multiplying the analytical result by 30%/28%=1.0714. The modified result is now 160.7 ppb which is ˜7% higher than the liquid analytical results showed. If the 150 ppm result was used it would show that the process was 7% more efficient at removing the heavy metals than was the actual case. This corrected value is more accurate hence the reason for performing the correction. The opposite is true in the event the liquid total solids from the separation process were higher than 30%. The correction of that value will be also needed to keep the results from understating the success of the process for removing the heavy metals if it was not corrected by using the same correction method. This same technique was used throughout all of the testing to ensure the heavy metals reported for all samples were comparable.

Target levels of heavy metals were equal to or below 125 ppb Ar, 250 ppb CD, 125 ppb Pb, and 29 ppb Hg. The data collected from each experiment described above is shown in Table 2.

TABLE 2

| | | TOTAL | HEAVY METAL CONC (ppb) | | | | TOTAL |
|---|---|---|---|---|---|---|---|
| pH | CHELANT | SOLIDS | As | Cd | Pb | Hg | HM CONC |
| FEED STOCK | | 22.6 | 101 | 1199 | 310 | 29.5 | |
| FEED STOCK (adj) | | 30 | 134 | 1592 | 412 | 39.2 | 2177 |
| 3.0 | WATER | 29.3 | 10 | 10 | 83 | 7.5 | |
| 3.0 adj | WATER | 30 | 10 | 10 | 85 | 7.7 | 113 |
| % REDUCTION | | | 92.4% | 99.4% | 79.3% | 80.4% | 94.8% |
| 3.0 | CITRIC | 32.8 | 12 | 12 | 80 | 9.2 | |
| 3.0 adj | CITRIC | 30 | 11 | 11 | 73 | 8.4 | 104 |
| % REDUCTION | | | 91.8% | 99.3% | 82.2% | 78.5% | 95.2% |
| 3.0 | EDTA | 29.9 | 12 | 232 | 63 | 8.4 | |
| 3.0 adj | EDTA | 30 | 16 | 232 | 66 | 8.2 | 322 |
| % REDUCTION | | | 91% | 85.4% | 84.6% | 78.5% | 85.2% |
| 3.0 | PEPTIDE | 31.2 | 15 | 20 | 79 | 8.7 | |
| 3.0 adj | PEPTIDE | 30 | 13 | 19 | 56 | 8.2 | 118 |
| % REDUCTION | | | 89.3% | 98.8% | 81.6% | 78.7% | 94.6% |
| 6.0 | WATER | 28.7 | 11 | 299 | 83 | 7.9 | |
| 6.0 adj | WATER | 30 | 12 | 313 | 87 | 8.3 | 419 |
| % REDUCTION | | | 91.4% | 80.4% | 78.9% | 78.9% | 80.7% |
| 6.0 | CITRIC | 34.1 | 18 | 194 | 75 | 9.3 | |
| 6.0 adj | CITRIC | 30 | 16 | 171 | 66 | 8.2 | 261 |
| % REDUCTION | | | 88.2% | 89.3% | 84% | 79.1% | 88% |
| 6.0 | EDTA | 32.6 | 18 | 57 | 31 | 9.2 | |
| 6.0 adj | EDTA | 30 | 17 | 53 | 27 | 8.5 | 106 |
| % REDUCTION | | | 87.6% | 96.7% | 93.1% | 78.4% | 95.1% |
| 6.0 | PEPTIDE | 33 | 23 | 216 | 78 | 8.9 | |
| 6.0 adj | PEPTIDE | 30 | 23 | 196 | 71 | 8.1 | 296 |
| % REDUCTION | | | 84.4% | 87.7% | 82.8% | 79.3% | 86.4% |
| 9.0 | WATER | 29.4 | 15 | 366 | 74 | 7.9 | |
| 9.0 adj | WATER | 30 | 15 | 374 | 76 | 8.1 | 472 |
| % REDUCTION | | | 88.6% | 76.8% | 81.7% | 79.4% | 78.3% |
| 9.0 | CITRIC | 32 | 14 | 269 | 60 | 8.7 | |
| 9.0 adj | CITRIC | 30 | 13 | 252 | 56 | 8.2 | 330 |
| % REDUCTION | | | 90.2% | 84.2% | 86.3% | 79.2% | 84.8% |
| 9.0 | EDTA | 30.2 | 20 | 76 | 40 | 8.9 | |
| 9.0 adj | EDTA | 30 | 20 | 76 | 40 | 8.8 | 144 |
| % REDUCTION | | | 85.2% | 95.3% | 90.3% | 77.4% | 93.4% |
| 9.0 | PEPTIDE | 32.5 | 23 | 379 | 87 | 9.11 | |
| 9.0 adj | PEPTIDE | 30 | 24 | 349 | 80 | 8.4 | 461 |

| | | | | | |
|---|---|---|---|---|---|
| % REDUCTION | 83.5% | 78% | 80.5% | 78.5% | 78.8% |

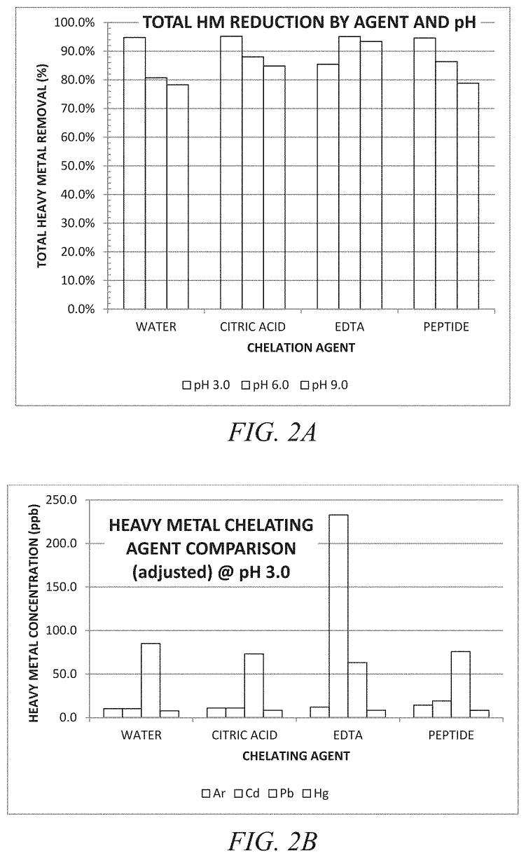

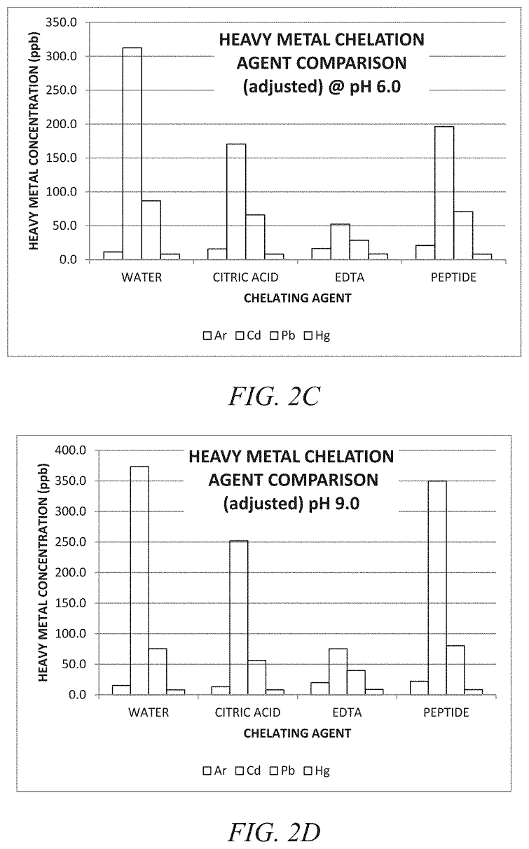

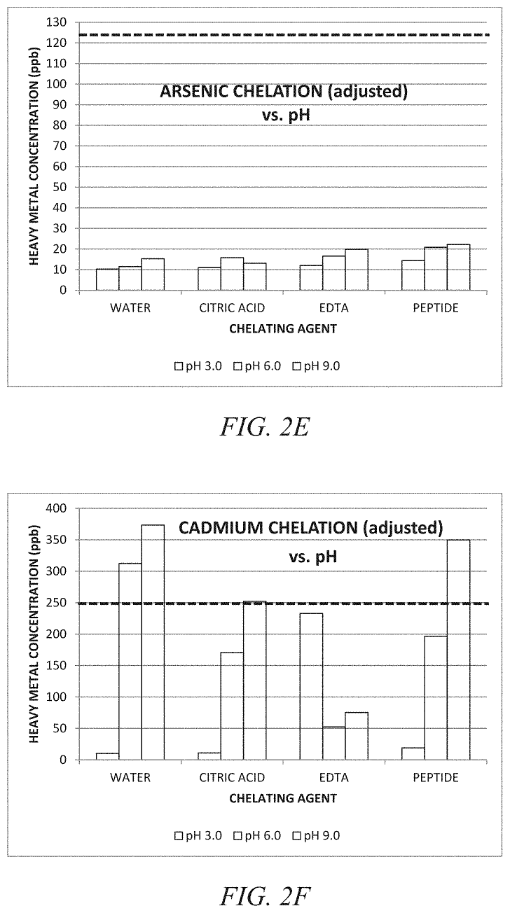

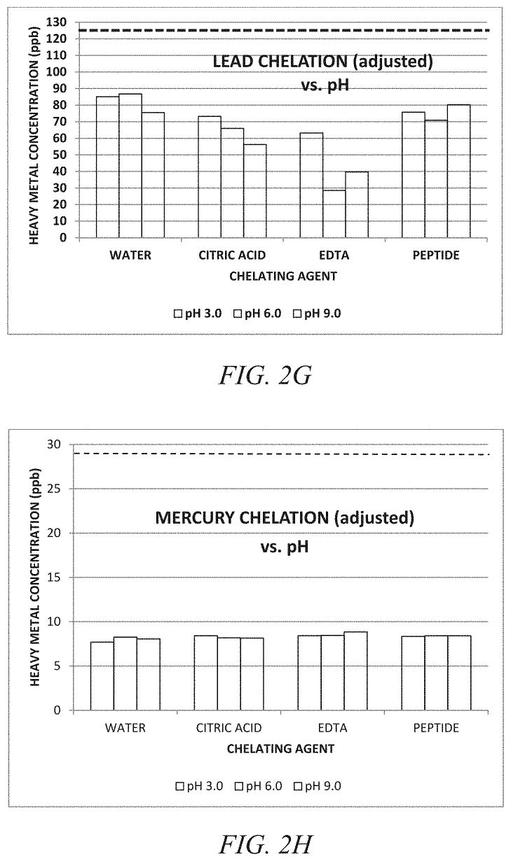

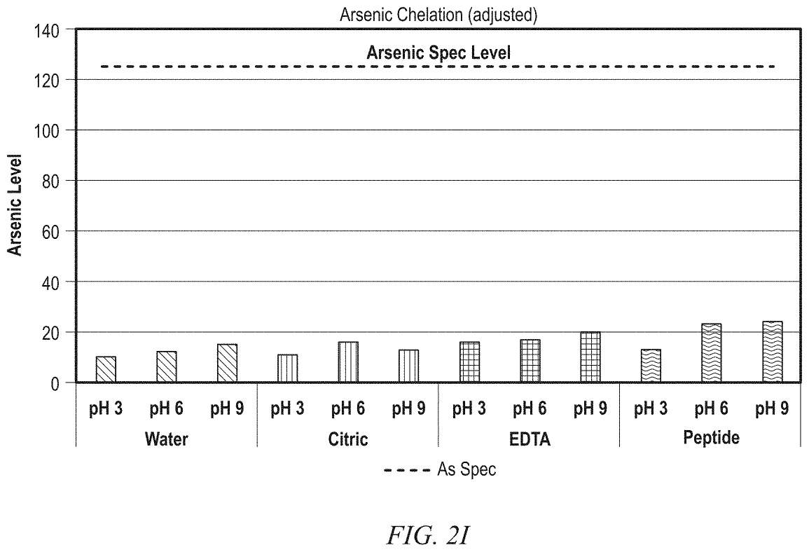

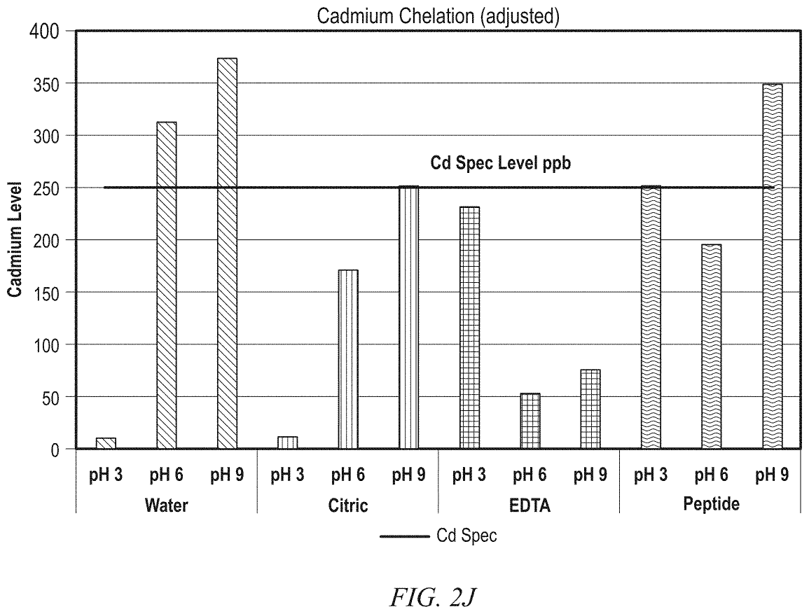

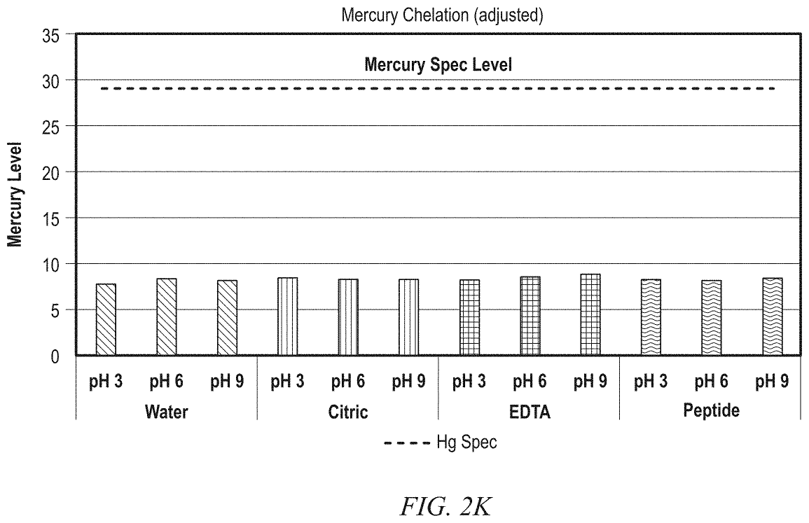

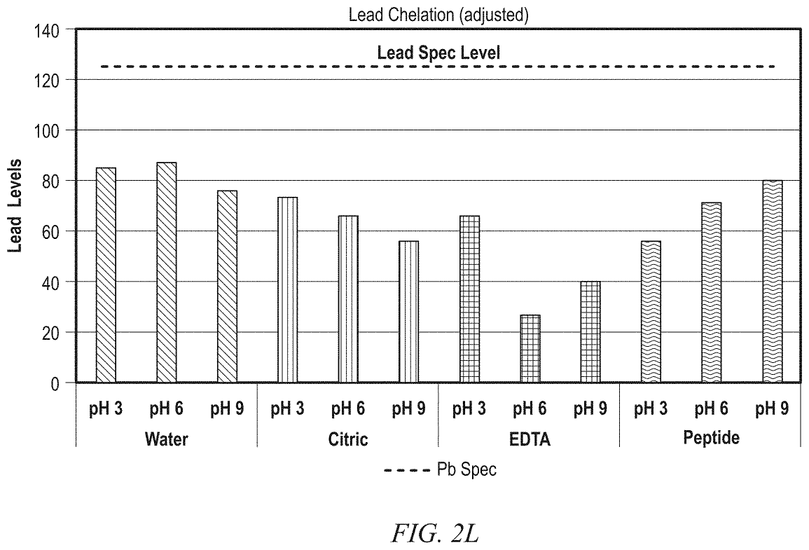

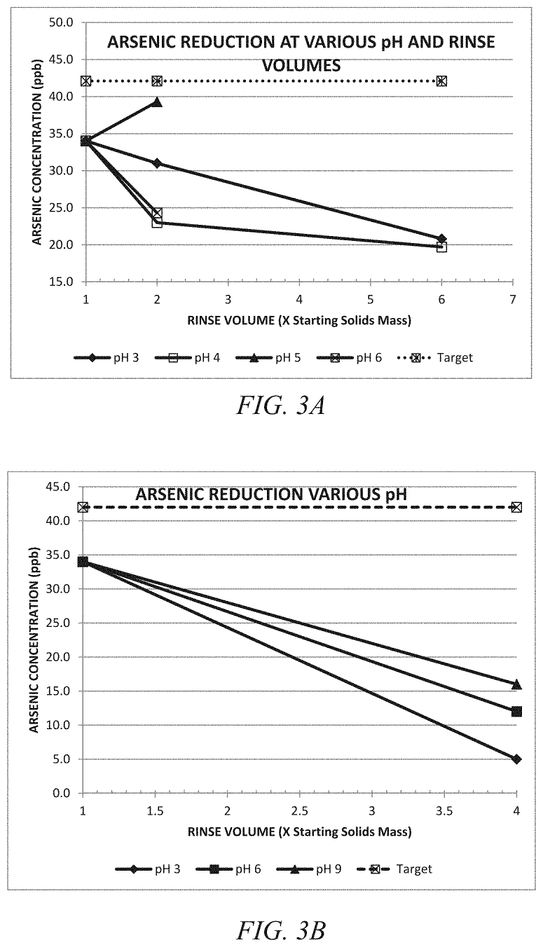

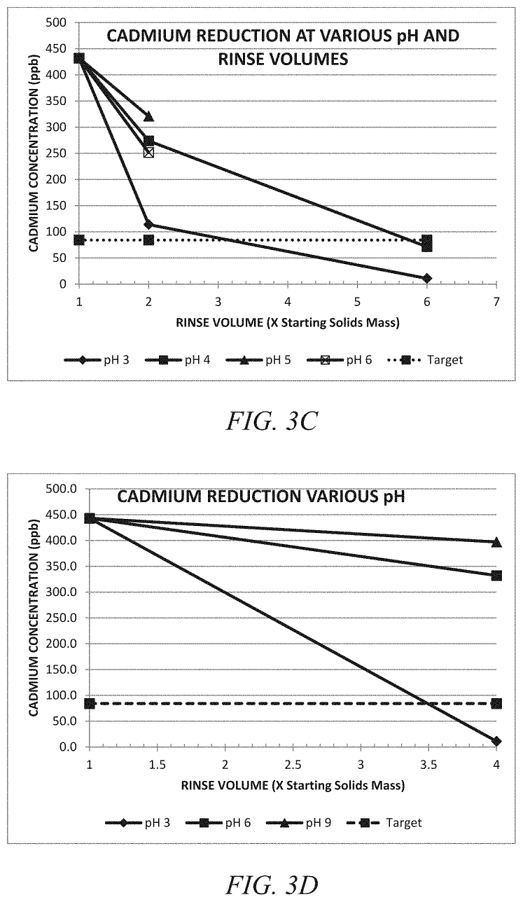

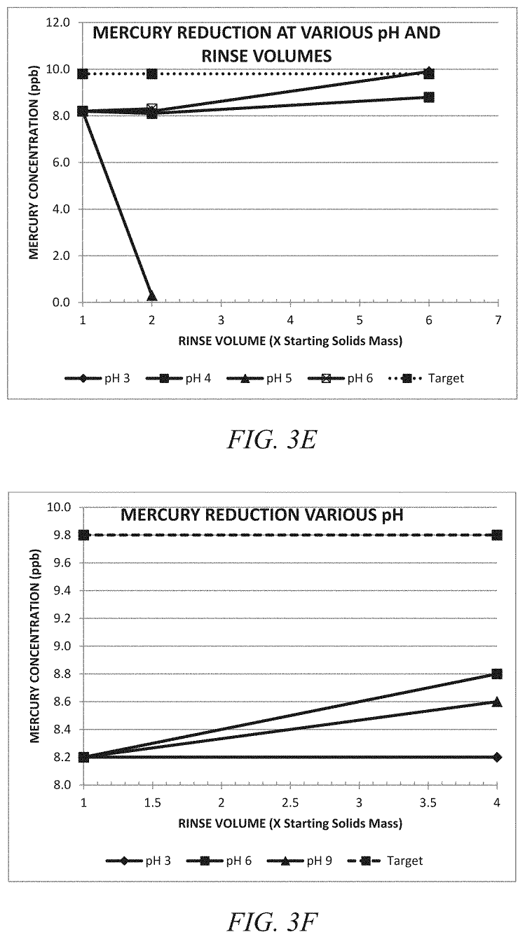

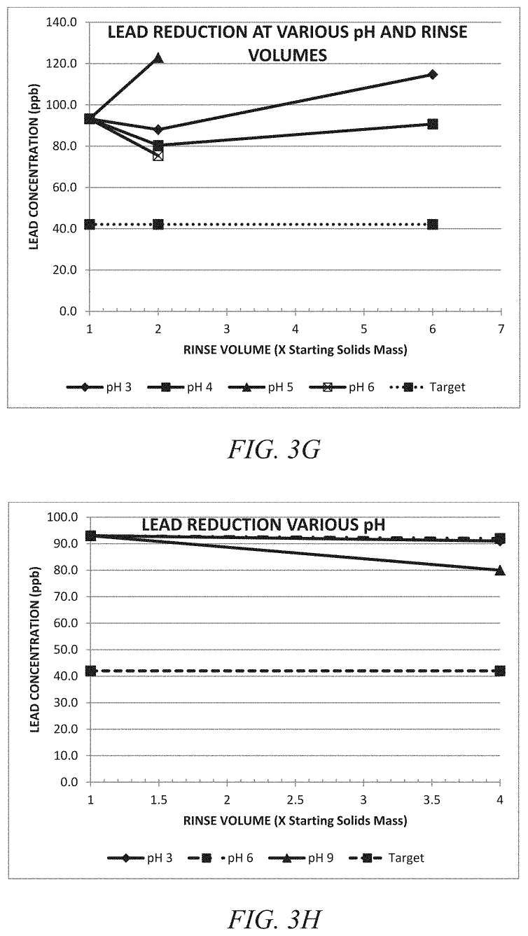

FIG. 2A provides an overview of the total % reduction of heavy metals using each chelator at each of three different pH values. As shown in FIG. 2A, all of the chelants tested reduced all the heavy metals tested by greater than 75%. As shown, some chelants reduced the levels by greater than or equal to 95% (e.g., citric acid at pH 3, EDTA at pH 6, and peptide at pH 3). Notably, the procedures for reducing heavy metal using hot water also reduced the heavy metal level by greater than or equal to 95%. Levels below the maximum allowable levels were achievable in all cases. Thus, organic protocols to remove the heavy metals were realized.

FIG. 2B shows the reduction of heavy metal at pH 3. As shown in FIG. 2B, in some embodiments, the peptide chelator can reduce the level of As from about 134 ppb to about 15 ppb at pH 3. In some embodiments, the peptide chelator can reduce the level of As from about 134 ppb to about 13 ppb at pH 3. In some embodiments, the peptide chelator can reduce the level of As by equal to or at least about 85% or about 95% at pH 3. In some embodiments, the peptide chelator can reduce the level of Cd from about 1199 ppb to about 20 ppb at pH 3. In some embodiments, the peptide chelator can reduce the level of Cd from about 1592 ppb to about 19 ppb at pH 3. In some embodiments, the peptide chelator can reduce the level of Cd by equal to or at least about 85% or about 99%. In some embodiments, the peptide chelator can reduce the level of Pb from about 310 ppb to about 79 ppb at pH 3. In some embodiments, the peptide chelator can reduce the level of Pb from about 412 ppb to about 56 ppb at pH 3. In some embodiments, the peptide chelator can reduce the level of Pb by equal to or at least about 75% or about 85% at pH 3. In some embodiments, the peptide chelator can reduce the level of Hg from about 29.5 ppb to about 8.7 ppb at pH 3. In some embodiments, the peptide chelator can reduce the level of Hg from about 39.2 ppb to about 8.2 ppb at pH 3. In some embodiments, the peptide chelator can reduce the level of Hg by equal to or at least about 70% or about 80% at pH 3.

As shown in FIG. 2B, in some embodiments, citric acid can reduce the level of As from about 101 ppb to about 12 ppb at pH 3. In some embodiments, citric acid can reduce the level of As from about 134 ppb to about 11 ppb at pH 3. In some embodiments, citric acid can reduce the level of As by equal to or at least about 85% or about 90% at pH 3. In some embodiments, citric acid can reduce the level of Cd from about 1199 ppb to about 12 ppb at pH 3. In some embodiments, citric acid can reduce the level of Cd from about 1592 ppb to about 11 ppb at pH 3. In some embodiments, citric acid can reduce the level of Cd by equal to or at least about 98% or about 99% at pH 3. In some embodiments, citric acid can reduce the level of Pb from about 310 ppb to about 80 ppb at pH 3. In some embodiments, citric acid can reduce the level of Pb from about 412 ppb to about 73 ppb at pH 3. In some embodiments, citric acid can reduce the level of Pb by equal to or at least about 75% or about 83% at pH 3. In some embodiments, citric acid can reduce the level of Hg from about 29.5 ppb to about 9.2 ppb at pH 3. In some embodiments, citric acid can reduce the level of Hg from about 39.2 ppb to about 8.4 ppb at pH 3. In some embodiments, citric acid can reduce the level of Hg by equal to or at least about 70% or about 80% at pH 3.

As shown in FIG. 2B, in some embodiments, EDTA can reduce the level of As from about 101 ppb to about 12 ppb at pH 3. In some embodiments, EDTA can reduce the level of As from about 134 ppb to about 16 ppb at pH 3. In some embodiments, EDTA can reduce the level of As by equal to or at least about 85% or about 90% at pH 3. In some embodiments, EDTA can reduce the level of Cd from about 1199 ppb to about 232 ppb at pH 3. In some embodiments, EDTA can reduce the level of Cd from about 1592 ppb to about 232 ppb at pH 3. In some embodiments, EDTA can reduce the level of Cd by equal to or at least about 80% or about 85% at pH 3. In some embodiments, EDTA can reduce the level of Pb from about 310 ppb to about 63 ppb at pH 3. In some embodiments, EDTA can reduce the level of Pb from about 412 ppb to about 66 ppb at pH 3. In some embodiments, EDTA can reduce the level of Pb by equal to or at least about 80% or about 85% at pH 3. In some embodiments, EDTA can reduce the level of Hg from about 29.5 ppb to about 8.4 ppb at pH 3. In some embodiments, EDTA can reduce the level of Hg from about 39.2 ppb to about 8.2 ppb at pH 3. In some embodiments, EDTA can reduce the level of Hg by equal to or at least about 70% or about 80% at pH 3.

As shown in FIG. 2B, in some embodiments, a water wash at a temperature of at least about 70° C. can reduce the level of As from about 101 ppb to about 10 ppb at pH 3. In some embodiments, water can reduce the level of As from about 134 ppb to about 10 ppb at pH 3. In some embodiments, water can reduce the level of As by equal to or at least about 90% or about 95% at pH 3. In some embodiments, water can reduce the level of Cd from about 1199 ppb to about 10 ppb at pH 3. In some embodiments, water can reduce the level of Cd from about 1592 ppb to about 10 ppb at pH 3. In some embodiments, water can reduce the level of Cd by equal to or at least about 98% or about 99% at pH 3. In some embodiments, water can reduce the level of Pb from about 310 ppb to about 83 ppb at pH 3. In some embodiments, water can reduce the level of Pb from about 412 ppb to about 85 ppb at pH 3. In some embodiments, the water can reduce the level of Pb by equal to or at least about 70% or about 75% at pH 3. In some embodiments, water can reduce the level of Hg from about 29.5 ppb to about 7.5 ppb at pH 3. In some embodiments, the peptide chelator can reduce the level of Hg from about 39.2 ppb to about 7.7 ppb at pH 3. In some embodiments, the peptide chelator can reduce the level of Hg by equal to or at least about 70% or about 80% at pH 3.

The pH 3.0 condition conclusions: All chelants provided nearly the same removal level for all HMs tested; between 85-95% of the HM content was removed from the protein sample; the lead remained in the highest concentration which was about the same for all chelants as well; there was a significant drop in the cadmium removal for the EDTA chelant; for total HM removal hot water @ pH 3.0 is a good technique for removing the heavy metals.

FIG. 2C shows the reduction of heavy metal at pH 6. As shown in FIG. 2C, in some embodiments, the peptide chelator can reduce the level of As from about 101 ppb to about 23 ppb at pH 6. In some embodiments, the peptide chelator can reduce the level of As from about 134 ppb to about 23 ppb at pH 6. In some embodiments, the peptide chelator can reduce the level of As by equal to or at least about 85% or about 90% at pH 6. In some embodiments, the peptide chelator can reduce the level of Cd from about 1199 ppb to about 216 ppb at pH 6. In some embodiments, the peptide chelator can reduce the level of Cd from about 1592 ppb to about 196 ppb at pH 6. In some embodiments, the peptide chelator can reduce the level of Cd by equal to or at least about 80% or about 85% at pH 6. In some embodiments, the peptide chelator can reduce the level of Pb from about 310 ppb to about 78 ppb at pH 6. In some embodiments, the peptide chelator can reduce the level of Pb from about 412 ppb to about 71 ppb at pH 6. In some embodiments, the peptide chelator can reduce the level of Pb by equal to or at least about 80% or about 85% at pH 6. In some embodiments, the peptide chelator can reduce the level of Hg from about 29.5 ppb to about 8.9 ppb at pH 6. In some embodiments, the peptide chelator can reduce the level of Hg from about 39.2 ppb to about 8.1 ppb at pH 6. In some embodiments, the peptide chelator can reduce the level of Hg by equal to or at least about 70% or about 80% at pH 6.

As shown in FIG. 2C, in some embodiments, citric acid can reduce the level of As from about 101 ppb to about 18 ppb at pH 6. In some embodiments, citric acid can reduce the level of As from about 134 ppb to about 16 ppb at pH 6. In some embodiments, citric acid can reduce the level of As by equal to or at least about 80% or about 90% at pH 6. In some embodiments, citric acid can reduce the level of Cd from about 1199 ppb to about 194 ppb at pH 6. In some embodiments, citric acid can reduce the level of Cd from about 1592 ppb to about 171 ppb at pH 6. In some embodiments, citric acid can reduce the level of Cd by equal to or at least about 80% or about 85% at pH 6. In some embodiments, citric acid can reduce the level of Pb from about 310 ppb to about 75 ppb at pH 6. In some embodiments, citric acid can reduce the level of Pb from about 412 ppb to about 66 ppb at pH 6. In some embodiments, citric acid can reduce the level of Pb by equal to or at least about 75% or about 83% at pH 6. In some embodiments, citric acid can reduce the level of Hg from about 29.5 ppb to about 9.3 ppb at pH 6. In some embodiments, citric acid can reduce the level of Hg from about 39.2 ppb to about 8.2 ppb at pH 6. In some embodiments, citric acid can reduce the level of Hg by equal to or at least about 70% or about 80% at pH 6.

As shown in FIG. 2C, in some embodiments, EDTA can reduce the level of As from about 101 ppb to about 18 ppb at pH 6. In some embodiments, EDTA can reduce the level of As from about 134 ppb to about 17 ppb at pH 6. In some embodiments, EDTA can reduce the level of As by equal to or at least about 85% or about 90% at pH 6. In some embodiments, EDTA can reduce the level of Cd from about 1199 ppb to about 57 ppb at pH 6. In some embodiments, EDTA can reduce the level of Cd from about 1592 ppb to about 53 ppb at pH 6. In some embodiments, EDTA can reduce the level of Cd by equal to or at least about 95% or about 97% at pH 6. In some embodiments, EDTA can reduce the level of Pb from about 310 ppb to about 31 ppb at pH 6. In some embodiments, EDTA can reduce the level of Pb from about 412 ppb to about 27 ppb at pH 6. In some embodiments, EDTA can reduce the level of Pb by equal to or at least about 85% or about 95% at pH 6. In some embodiments, EDTA can reduce the level of Hg from about 29.5 ppb to about 9.2 ppb at pH 6. In some embodiments, EDTA can reduce the level of Hg from about 39.2 ppb to about 8.5 ppb at pH 6. In some embodiments, EDTA can reduce the level of Hg by equal to or at least about 70% or about 80% at pH 6.

As shown in FIG. 2C, in some embodiments, a water wash at a temperature of at least about 70° C. can reduce the level of As from about 101 ppb to about 11 ppb at pH 6. In some embodiments, water can reduce the level of As from about 134 ppb to about 12 ppb at pH 6. In some embodiments, water can reduce the level of As by equal to or at least about 90% or about 95% at pH 6. In some embodiments, water can reduce the level of Cd from about 1199 ppb to about 299 ppb at pH 6. In some embodiments, water can reduce the level of Cd from about 1592 ppb to about 313 ppb at pH 6. In some embodiments, water can reduce the level of Cd by equal to or at least about 75% or about 80% at pH 6. In some embodiments, water can reduce the level of Pb from about 310 ppb to about 83 ppb at pH 6. In some embodiments, water can reduce the level of Pb from about 412 ppb to about 87 ppb at pH 6. In some embodiments, the water can reduce the level of Pb by equal to or at least about 70% or about 75% at pH 6. In some embodiments, water can reduce the level of Hg from about 29.5 ppb to about 7.9 ppb at pH 6. In some embodiments, the peptide chelator can reduce the level of Hg from about 39.2 ppb to about 8.3 ppb at pH 6. In some embodiments, the peptide chelator can reduce the level of Hg by equal to or at least about 70% or about 80% at pH 6.

Results at pH 6.0 showed that arsenic was reduced the most by EDTA. Arsenic and mercury were removed to about the same levels with all chelants. Cadmium, and to a lesser degree lead, was removed most efficiently by the EDTA at this pH condition.

FIG. 2D shows the reduction of heavy metal at pH 9. As shown in FIG. 2D, in some embodiments, the peptide chelator can reduce the level of As from about 101 ppb to about 23 ppb at pH 9. In some embodiments, the peptide chelator can reduce the level of As from about 134 ppb to about 24 ppb at pH 9. In some embodiments, the peptide chelator can reduce the level of As by equal to or at least about 85% or about 90% at pH 9. In some embodiments, the peptide chelator can reduce the level of Cd from about 1199 ppb to about 379 ppb at pH 9. In some embodiments, the peptide chelator can reduce the level of Cd from about 1592 ppb to about 349 ppb at pH 9. In some embodiments, the peptide chelator can reduce the level of Cd by equal to or at least about 70% or about 75% at pH 9. In some embodiments, the peptide chelator can reduce the level of Pb from about 310 ppb to about 87 ppb at pH 9. In some embodiments, the peptide chelator can reduce the level of Pb from about 412 ppb to about 80 ppb at pH 9. In some embodiments, the peptide chelator can reduce the level of Pb by equal to or at least about 70% or about 80% at pH 9. In some embodiments, the peptide chelator can reduce the level of Hg from about 29.5 ppb to about 9.1 ppb at pH 9. In some embodiments, the peptide chelator can reduce the level of Hg from about 39.2 ppb to about 8.4 ppb at pH 9. In some embodiments, the peptide chelator can reduce the level of Hg by equal to or at least about 70% or about 80% at pH 9.

As shown in FIG. 2D, in some embodiments, citric acid can reduce the level of As from about 101 ppb to about 14 ppb at pH 9. In some embodiments, citric acid can reduce the level of As from about 134 ppb to about 13 ppb at pH 9. In some embodiments, citric acid can reduce the level of As by equal to or at least about 85% or about 90% at pH 9. In some embodiments, citric acid can reduce the level of Cd from about 1199 ppb to about 269 ppb at pH 9. In some embodiments, citric acid can reduce the level of Cd from about 1592 ppb to about 252 ppb at pH 9. In some embodiments, citric acid can reduce the level of Cd by equal to or at least about 75% or about 85% at pH 9. In some embodiments, citric acid can reduce the level of Pb from about 310 ppb to about 60 ppb at pH 9. In some embodiments, citric acid can reduce the level of Pb from about 412 ppb to about 56 ppb at pH 9. In some embodiments, citric acid can reduce the level of Pb by equal to or at least about 80% or about 85% at pH 9. In some embodiments, citric acid can reduce the level of Hg from about 29.5 ppb to about 8.7 ppb at pH 9. In some embodiments, citric acid can reduce the level of Hg from about 39.2 ppb to about 8.2 ppb at pH 9. In some embodiments, citric acid can reduce the level of Hg by equal to or at least about 70% or about 80% at pH 9.

As shown in FIG. 2D, in some embodiments, EDTA can reduce the level of As from about 101 ppb to about 20 ppb at pH 9. In some embodiments, EDTA can reduce the level of As from about 134 ppb to about 20 ppb at pH 9. In some embodiments, EDTA can reduce the level of As by equal to or at least about 80% or about 90% at pH 9. In some embodiments, EDTA can reduce the level of Cd from about 1199 ppb to about 76 ppb at pH 9. In some embodiments, EDTA can reduce the level of Cd from about 1592 ppb to about 76 ppb at pH 9. In some embodiments, EDTA can reduce the level of Cd by equal to or at least about 90% or about 95% at pH 9. In some embodiments, EDTA can reduce the level of Pb from about 310 ppb to about 40 ppb at pH 9. In some embodiments, EDTA can reduce the level of Pb from about 412 ppb to about 40 ppb at pH 9. In some embodiments, EDTA can reduce the level of Pb by equal to or at least about 85% or about 90% at pH 9. In some embodiments, EDTA can reduce the level of Hg from about 29.5 ppb to about 8.9 ppb at pH 9. In some embodiments, EDTA can reduce the level of Hg from about 39.2 ppb to about 8.8 ppb at pH 9. In some embodiments, EDTA can reduce the level of Hg by equal to or at least about 70% or about 80% at pH 9.

As shown in FIG. 2D, in some embodiments, a water wash at a temperature of at least about 70° C. can reduce the level of As from about 101 ppb to about 15 ppb at pH 9. In some embodiments, water can reduce the level of As from about 134 ppb to about 15 ppb at pH 9. In some embodiments, water can reduce the level of As by equal to or at least about 85% or about 90% at pH 9. In some embodiments, water can reduce the level of Cd from about 1199 ppb to about 366 ppb at pH 9. In some embodiments, water can reduce the level of Cd from about 1592 ppb to about 374 ppb at pH 9. In some embodiments, water can reduce the level of Cd by equal to or at least about 70% or about 80% at pH 9. In some embodiments, water can reduce the level of Pb from about 310 ppb to about 74 ppb at pH 9. In some embodiments, water can reduce the level of Pb from about 412 ppb to about 76 ppb at pH 9. In some embodiments, the water can reduce the level of Pb by equal to or at least about 75% or about 80% at pH 9. In some embodiments, water can reduce the level of Hg from about 29.5 ppb to about 7.9 ppb at pH 9. In some embodiments, the peptide chelator can reduce the level of Hg from about 39.2 ppb to about 8.1 ppb at pH 9. In some embodiments, the peptide chelator can reduce the level of Hg by equal to or at least about 70% or about 80% at pH 9.

FIGS. 2E-2H show the acceptable metal levels as a dashed line. As shown in FIGS. 2E-2H, the heavy metal levels were reduced to acceptable levels for nearly all metals and for nearly all chelators and wash procedures. As shown in FIGS. 2A-2H, changing extraction pH made an impact on the removal efficiency and the most effective pH is not the same for all HM elements tested or all chelators.

As shown in FIG. 2E, arsenic is removed at the lower pH 3.0 by all chelating agents. All chelants and conditions achieved levels significantly below the minimum needed. As shown in FIG. 2F, at pH 3.0 water, citric acid, and peptide were effective. Cadmium was removed efficiently at pH 6.0 with EDTA. Each test produced product below target minimum level. Water, citric acid and peptide were effective at pH 3.0. EDTA worked at the pH 6 and 9 levels but not as good as water, citric acid and peptide at the lower pH range. As shown in FIG. 2G, EDTA removed lead at least as well as the other chelants and was most efficient at pH was 6.0. All chelants and conditions achieved levels below the minimum metal levels. As shown in FIG. 2H, mercury was removed by low pH water followed by citric acid. EDTA was the least effective especially at the more alkaline conditions. You can see below the target minimum level we need to achieve for mercury content in the product. All chelants and conditions achieved levels below the minimum metal levels.

FIGS. 2I-2L show the data for the adjusted heavy metals from Table 2.

The lab tests show that the protein and heavy metal entities can be separated by using decanting centrifuges. Microfiltration (“MF”) and/or ultrafiltration (“UF”) membranes may be used instead of centrifuges. Large scale test work showed that centrifuges and decanters can be utilized to separate the rice protein isolate from the mixture and the resulting rice protein isolate cake separated out can be re-suspended in hot water and separated again with either the decanter or a centrifuge. The amount of wash water required to wash the chelant along with the chelated heavy metals, fat, ash, peptides, and amino acids from the rice protein isolate varied between a range of 4× to 10× of the starting mass of the heavy metal contaminated plant protein mixture.

Test work showed that in addition to centrifuges and decanters other separation technologies could be successfully applied to separate the protein isolate from the low molecular weight carbohydrate fractions, ash, fat, peptide fragments, and amino acids. The technologies that can also be employed in addition to decanters and centrifuges to perform the rice protein isolate separation from the chelant and the chelated heavy metals are described as follows. Microfiltration (MF) and Ultrafiltration (UF) crossflow membrane technology can be utilized along with very selective pore size membranes to get very precise separations from the protein isolate. UF Membrane with molecular retention ranging from 1,000 Dalton to 800,000 Daltons will allow the diafiltration (washing) of the chelants out of the rice protein mixture with elevated temperature water through the membrane while retaining the rice protein mixture allowing the desired separation of the chelant containing the chelated heavy metals from the heavy metal reduced protein isolate. Testing demonstrated the amount of diafiltration water required to effectively wash out the chelant and the heavy metals varied between a range of 4× to 10× of the starting mass of the heavy metal contaminated protein mixture. Due to the very highly controlled pore size of the membranes high yields of protein isolate can be achieved from the application of this technology.

Filter presses of various designs can be used to filter the rice protein isolate from the mixture and then the resulting cake can be washed in situ with various amounts of elevated temperature water to again wash the chelant and the chelated heavy metals from the rice protein isolate mixture. Wash volumes again can range between 2× and 10× of the starting mass of the heavy metal contaminated protein mixture. Protein yields can be somewhat lower with this technology as some of the protein can pass through the filter media used.

Rotary vacuum filter drums can be used to filter the rice protein isolate from the mixture and then the resulting cake can be washed either in situ or the rice protein cake can be re-suspended and re-filtered with various amounts of hot water to again wash the chelant and the chelated heavy metals from the rice protein isolate mixture. Wash volumes again can range between 2× and 10× of the starting mass of the heavy metal contaminated protein mixture. As with the filter press technology rotary vacuum filter drums have been used and have been shown to provide protein yields somewhat lower than with the membrane technologies.

It is noted that these protocols could be used for reducing the HM in products during manufacturing and/or to remediate the HM content in previously produced protein products.

### Example 3

### Introduction and Objectives

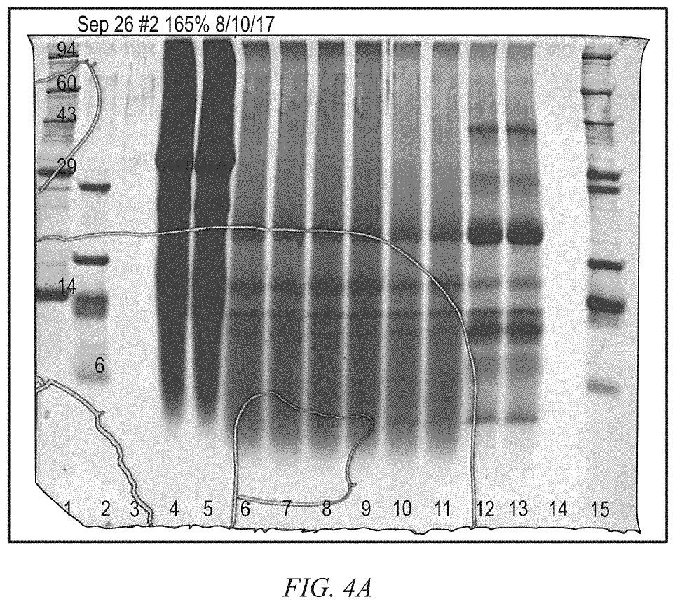

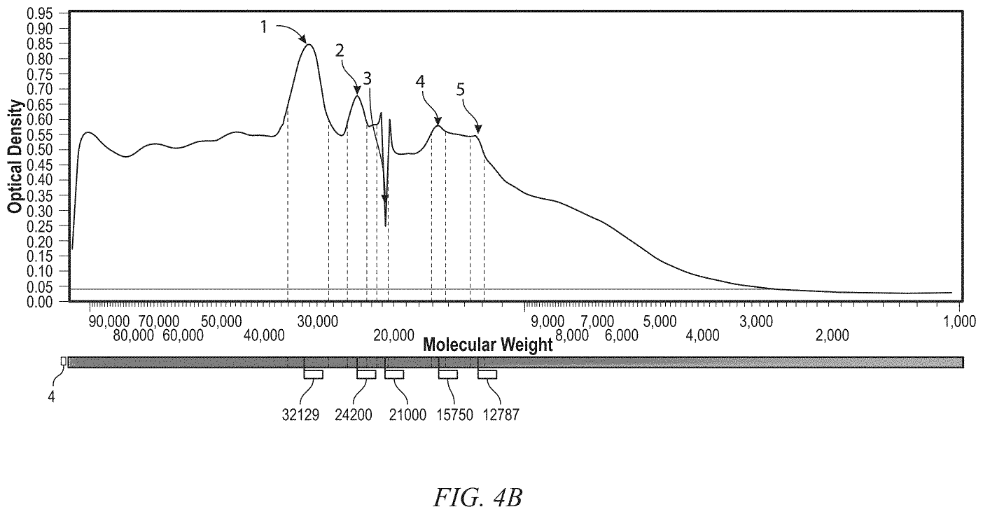

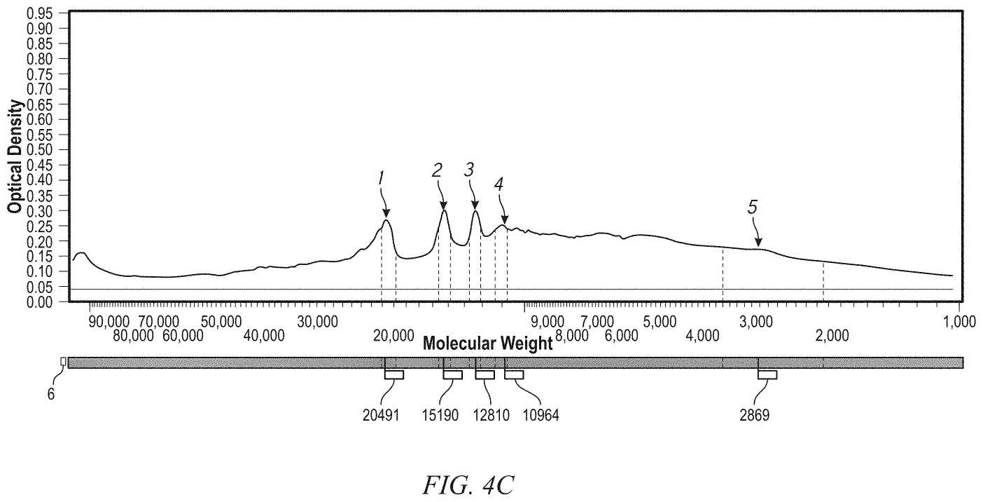

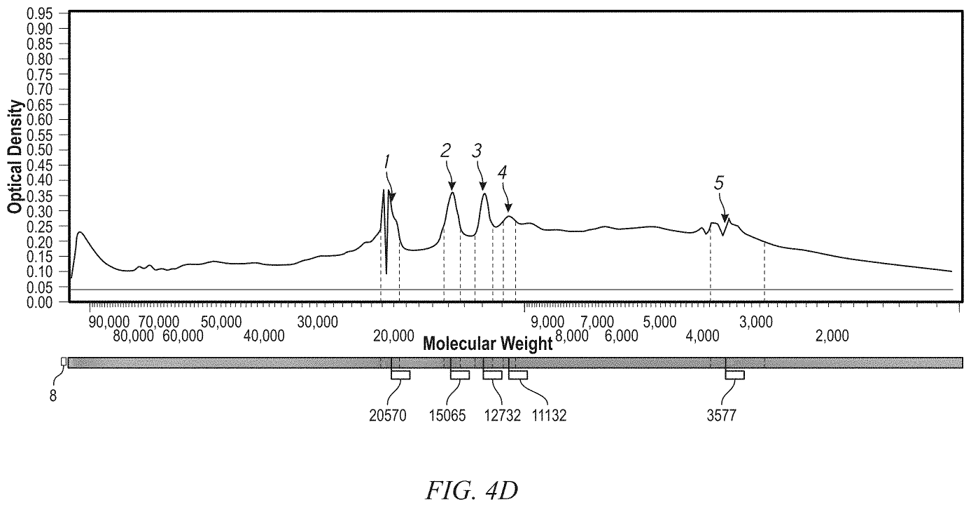

A rice protein sample with heavy metal contamination was used to perform the following heavy metal remediation tests. This testing was used to demonstrate that, using the procedures disclosed herein, in some embodiments, some heavy metals may be removed using washing methods without chelating agents. Briefly, a fixed quantity of powdered protein was added to a fixed amount of pH adjusted DI water. The protein isolate water mixture was adjusted to pH values of 3, 4, 5, or 6 as shown in FIGS. 3A-3H. The pH was adjusted using a dilute 10% by weight concentrated 38% HCl solution and by measuring the pH using a temperature correcting pH meter. After the pH was adjusted, the mixtures were agitated for 5 minutes at about 70° C. The solutions were then allowed to sit for 15-20 minutes in a temperature controlled hot water bath at 70° C. The protein isolate mixture was then centrifuged at 9000 RPM for 3 minutes. The supernatant was then extracted. Depending on the wash method, as shown in FIGS. 3A-3H, the dilution and concentration procedure could be repeated. Starting samples, 2× wash samples, 4× wash samples and 6× wash samples were submitted for analysis targeting heavy metal arsenic (Ar), cadmium (Cd), mercury (Hg), and lead (Pb). Data:

Attached as FIGS. 3A-3H are the graphs showing the data and washes performed. As can be seen in some of the analytical results, in some instances metal levels increased. Without being bound to a particular theory, this may be due to the dissolution and removal of some of the peptide/protein product with the soluble fraction during decanting without dissolution removal of the same quantity of heavy metal.

Tables 3 and 4 contain raw data with analytical results obtained from the disclosed test procedures.

TABLE 3

| SAMPLE | | | ANALYTICAL (ppb) | | | | |
|---|---|---|---|---|---|---|---|
| DESCRIPTION | WASH | pH | % TS | Ar | Cd | Hg | Pb |
| Target Maximum HM | 0X | 5.9 | 95.0 | 125 | 250 | 29 | 125 |
| Levels (dry solids) | | | | | | | |
| Target Max HM | 0X | 5.9 | 32.0 | 42.1 | 84.2 | 9.8 | 42.1 |
| Levels (adjusted) | | | | | | | |
| Target Max HM | 0X | 5.9 | 3.5 | 4.6 | 9.2 | 11 | 4.6 |
| Levels (adjusted) | | | | | | | |
| Feedstock HM Levels | 0X | 5.9 | 95.0 | 114 | 1418 | 25 | 240 |
| (C of A source) | | | | | | | |
| Feedstock HM Levels | 0X | 5.9 | 95.0 | 101 | 1199 | 24.5 | 310 |
| (Analytical test 1) | | | | | | | |
| Feedstock HM Levels | 0X | 5.9 | 95.0 | 88 | 1330 | 23.4 | 280 |
| (Analytical test 2) | | | | | | | |
| Feedstock HM Levels | 0X | 5.9 | 95.0 | 101 | 1316 | 24.3 | 277 |
| (Ave. Analytical tests) | | | | | | | |
| Feedstock HM Levels | 0X | 5.9 | 32.0 | 34 | 443 | 8.2 | 93 |
| (adjusted 32% solids) | | | | | | | |
| Feedstock HM Levels | 0X | 5.9 | 3.5 | 3.7 | 48.5 | 0.9 | 10.2 |
| (adjusted 3.5% solids) | | | | | | | |
| Decanted Test Sample | 2X | 3 | 32.0 | 31.0 | 114 | 8.2 | 88.0 |
| Decanted Test Sample | 6X | 3 | 29.3 | 19.0 | 10.0 | 9.0 | 105 |
| Decanted Test Sample | 6X | 3 | 32.0 | 20.8 | 10.9 | 9.9 | 115 |
| (solids adjusted 32%) | | | | | | | |
| Decanted Test Sample | 2X | 4 | 37.4 | 23.0 | 320 | 9.5 | 94.0 |
| Decanted Test Sample | 2X | 4 | 32.0 | 19.7 | 274 | 8.1 | 80.4 |
| (solids adjusted 32%) | | | | | | | |
| Decanted Test Sample | 6X | 4 | 36.7 | 22.0 | 82.0 | 10.1 | 104 |
| Decanted Test Sample | 6X | 4 | 32.0 | 19.2 | 71.5 | 8.8 | 90.7 |
| (solids adjusted 32%) | | | | | | | |
| Decanted Test Sample | 2X | 5 | 375 | 46.0 | 376 | 0.3 | 144 |
| Decanted Test Sample | 2X | 5 | 32.0 | 39.3 | 321 | 0.3 | 123 |
| (solids adjusted 32%) | | | | | | | |
| Decanted Test Sample | 2X | 6 | 36.9 | 28.0 | 290 | 9.5 | 87.0 |
| Decanted Test Sample | 2X | 6 | 32.0 | 24.3 | 252 | 8.3 | 75.4 |
| (solids adjusted 32%) | | | | | | | |

TABLE 4

| SAMPLE | WASH | pH | ANALYTICAL (ppb) | | | | |
|---|---|---|---|---|---|---|---|
| DESCRIPTION | LEVEL | TEST | % TS | Ar | Cd | Hg | Pb |
| Target Maximum HM | 0X | 5.9 | 95.0 | 125 | 250 | 29 | 125 |
| Levels (dry solids) | | | | | | | |
| Target Max HM | 0X | 5.9 | 32.0 | 42.1 | 84.2 | 9.8 | 42.1 |
| Levels (adjusted) | | | | | | | |
| Feedstock HM Levels | 0X | 5.9 | 95.0 | 114 | 1418 | 25 | 240 |
| (C of A source) | | | | | | | |
| Feedstock HM Levels | 0X | 5.9 | 95.0 | 101 | 1199 | 24.5 | 310 |
| (Analytical test 1) | | | | | | | |
| Feedstock HM Levels | 0X | 5.9 | 95.0 | 88 | 1330 | 23.4 | 280 |
| (Analytical test 2) | | | | | | | |
| Feedstock HM Levels | 0X | 5.9 | 95.0 | 101 | 1316 | 24.3 | 277 |
| (Ave. Analytical tests) | | | | | | | |
| Feedstock HM Levels 32% | 0X | 5.9 | 32.0 | 34 | 443 | 8.2 | 93 |
| (adjusted solids) | | | | | | | |
| Decanted Test Sample | 4X | 3.0 | 29.25 | <10 | 10 | 7.5 | 83 |
| Decanted Test Sample | 4X | 3.0 | 32.0 | | 10.9 | 8.2 | 90.8 |
| (adjusted 32% solids) | | | | | | | |
| Decanted Test Sample | 4X | 6.0 | 28.78 | 11 | 299 | 7.9 | 83 |
| Decanted Test Sample | 4X | 6.0 | 32.0 | 12.2 | 332 | 8.8 | 92 |
| (adjusted 32% solids) | | | | | | | |
| Decanted Test Sample | 4X | 9.0 | 29.49 | 15 | 366 | 7.9 | 74 |
| Decanted Test Sample | 4X | 9.0 | 32.0 | 16.3 | 397 | 8.6 | 80 |
| (adjusted 32% solids) | | | | | | | |

### Results:

### Arsenic (Ar):

The results for the arsenic heavy metal reduction using water are shown in FIGS. 3A-3B. The trial indicated that pH 3 and 4 were the target pH levels for treatment and further removal of arsenic. After 2× wash the pH 5 sample was higher in arsenic than the feed. Acid washes at various pH levels were able to reduce arsenic levels.

### Cadmium (Cd):

The result for cadmium heavy metal remediation work is shown in FIGS. 3C-3D. The starting sample protein had significant levels of cadmium that were above the maximum allowed target level. Cadmium levels were reduced with all washes and the more acidic pH 3 wash provided the greatest reduction. After the 3× wash at pH 3, the sample was under the target specification for cadmium. Cadmium was also reduced with pH 4 solution but required additional rinse volumes than the pH 3 solution.

### Mercury (Hg):

The result for mercury heavy metal remediation work is shown in FIGS. 3E-3F. In almost every sample there was more Hg at the end of the test rinses than at the start The pH 5 sample showed a significant reduction.

### Lead (Pb):

The result for lead heavy metal remediation work is shown in FIGS. 3G-3H. The lead analysis showed again more lead in the 6× wash than the starting material. The pH 5 wash immediately showed more lead than the starting material while at 2× wash the other pH levels showed ˜10-20% reduction in lead content of the centrifuged protein mass. None of the samples were shown to reduce the lead below the target maximum level.

### Test Observations:

It was noted that more acidic rinses removed more heavy metal from the protein for arsenic and cadmium. Both cadmium and arsenic levels were reduced below the maximum allowed food standards levels with the low pH treatment. Little impact was observed on the mercury but starting mercury levels were below the maximum target allowed so all samples passed the mercury content standard. None of the pH levels and wash levels for which data was available reduced the lead below maximum standards. This results with lead may be due to lead having amphoterism, meaning it is reactive and soluble at both high and low pH ranges.

### Example 4

### Synthesis and Characterization of a Peptide Chelator

Rice-based peptide chelators were prepared by the following procedures. 100 g of Silk-80 (AXIOM protein product: Moisture: 2.7%; Protein 81%; Fat 1.2%; Ash <4.5%, Fiber: <10%, Carbohydrate <13.3%) was placed into agitator and agitated with 233 g of hot 50° C. RO/DI water producing 300 g of solution (˜30% total solids). To this solution was added 3.6 g (300 ppm) CaCl₂). To this solution was added 10% NaOH to bring pH to 8.5 (+/−0.1). To this mixture was added Alcalase® (an alkaline protease enzyme) at 2% by weight of the protein dry weight. The solution was agitated at 50° C. for 2 hours at which time an aliquot was removed and quenched (using procedures described below) to produce a first peptide chelator sample (K-1). The solution was agitated at 50° C. for an additional 2 hours (4 hours total) at which time a second aliquot was removed and quenched (using procedures described below) to produce a second peptide chelator sample (K-2). The solution was agitated at 50° C. for an additional 2 hours (6 hours total) at which time the solution was quenched (using procedures described below) to produce a third peptide chelator sample (K-3).

To perform the quench, the mixture was heated to 80-85° C. and held for 10 minutes to deactivate the enzyme. After 10-minute hold time the mixture was cooled to 50° C., the mixture was then centrifuged causing the solids to separate via G-forces from the peptide solution. The supernatant containing the peptide chelators was decanted and the weight of total solids was measured. The supernatant was collected for use as a chelator. A dilute solution of peptides was obtained from this enzyme hydrolysis of rice protein. This product was filtered and stored for use during chelation experiments.

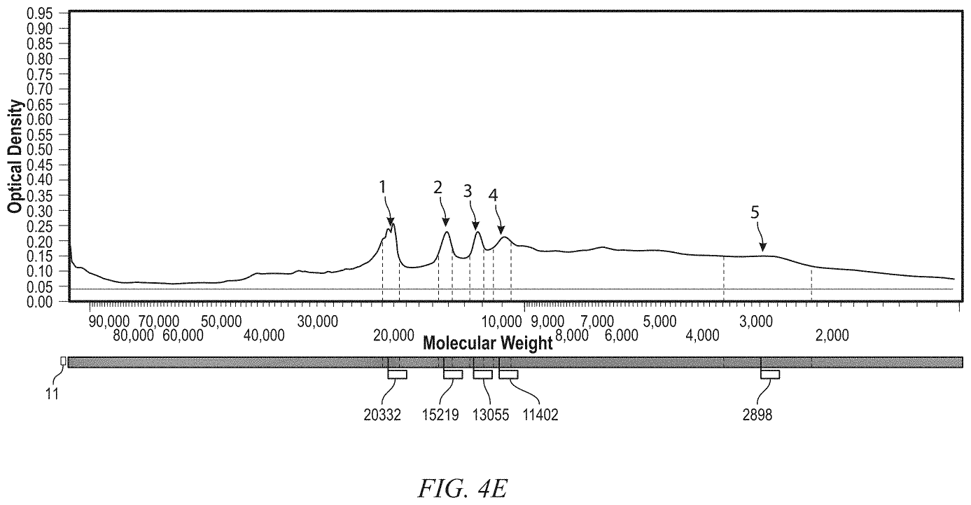

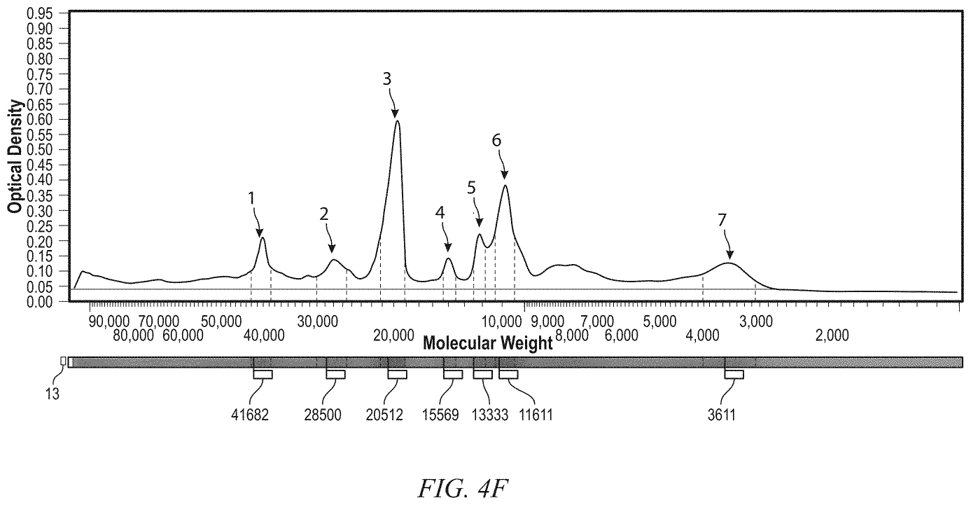

FIG. 4A shows the results of a polyacrylamide gel electrophoresis (“PAGE”) peptide separation. The PAGE analysis uses the property that proteins and peptides migrate at varying rates through a polyacrylamide gel when an electric field is applied across the gel depending on the unique amount of charge and molecular weight of the protein and peptide entities. The difference in charge is caused by the different charged functional groups a particular protein may have. The PAGE analysis was performed by Kendrick Laboratories, Inc., an independent analytical lab located at 1202 Ann St., Madison, Wis. 53713 (800-462-3417). The methods used in preparation of this PAGE are as follows:

The samples were weighed, dissolved in SDS Sample Buffer without reducing agents, and heated in a boiling water bath for 5 minutes. The samples were cooled, briefly centrifuged, and the protein concentration of the supernatant was then determined using the BCA Assay (Smith et. al. Anal. Biochem. 150: 76-85, 1985, and Pierce Chemical Co., Rockford, Ill.). Following the BCA, the samples were prepared in sample buffer with reducing agents containing 2.3% sodium dodecyl sulfate (SDS), 10% glycerol, 50 mM dithiothreitol, and 63 mM tris, pH 6.8. Following buffer addition, the samples were heated in a boiling water bath for 5 minutes. The samples were briefly centrifuged and the supernatant was loaded on the gel.

SDS slab gel electrophoresis was carried out using 16.5% acrylamide peptide slab gels (Shagger, H. and Jagow, G. Anal. Biochem. 166:368, 1987) (0.75 mm thick). SDS slab gel electrophoresis was started at 15 mAmp/gel for the first four hours and then carried out overnight at 12 mAmp/gel as for the separation of peptides. The slab gels were stopped once the bromophenol blue front had migrated to the end of the slab gel. Following slab gel completion, the gels were stained with Coomassie blue dye, destained in 10% acetic acid until a clear background was obtained, and dried between cellophane sheets.

The following proteins (Sigma Chemical Co., St. Louis, Mo. and EMD Millipore, Billerica, Mass.) were added as molecular weight standards: phosphorylase A (94,000), catalase (60,000), actin (43,000), carbonic anhydrase (29,000), lysozyme (14,000), myoglobin (I+III, 56-153) (10,600), Myoglobin (I, 56-131)(8,160), myoglobin (II 1-55)(6,210), glucagon (3,480), and myoglobin (III, 132-153)(2,510).

The stained gels were digitized over the appropriate optical density range using a calibrated GE Healthcare Image Scanner III. Molecular weights were calculated from the molecular weight standards using Phoretix 1D software (version 11.2) with a Windows 7 compatible computer and a first order lagrange molecular weight curve.

The PAGE work was done with protein and peptide standards of well characterized molecular weight to compare the molecular weights of the supplied peptide samples for analysis. A photo copy of the actual gel plate image with tracks in duplicate is shown on FIG. 4A. Table 5 shows the track (lane) number and sample that is on the respective track. Table 6 shows the total protein results as a percentage of sample weight. This table provides details regarding the relative protein concentration of samples that were subjected to the PAGE procedure. The relative protein concentrations used in the PAGE protocol varied from 459 to 1109 μg/L between the various protein/peptide fractions tested. As can be seen the raw material lot had the highest % of protein. This may account for why tracks 4 and 5 are darker than the other tracks. A more dilute solution would have reduced the optical density of those two tracks. However, a samples were within a range whereby good comparison of peaks was possible. The protein concentrations were measured against a protein standard using the BCA analytical protocol as stated above. BCA utilizes a protein binding dye and UV absorption technology to determine the protein concentrations for each track. 50 μg of each protein sample was placed on each track for PAGE development.

TABLE 5
Key to Loading Gel SC p.26 #2.

| Lane | Sample | μg Protein | μg Sample |
|---|---|---|---|
| 1 | High Range Molecular | — | — |
| | Weight Standards | | |
| 2 | Low Range Molecular | — | — |
| | Weight Standards | | |
| 3 | Sample Buffer Blank | — | — |
| 4 | K-5: Raw material | 50 | 1109 |
| | lot# HZN16003E | | |
| 5 | K-5: Raw material | 50 | 1109 |
| | lot# HZN16003E | | |
| 6 | K-1: Enzyme 2 hr hold | 50 | 597 |
| 7 | K-1: Enzyme 2 hr hold | 50 | 597 |
| 8 | K-2: Enzye 4 hr hold | 50 | 518 |
| 9 | K-2: Enzye 4 hr hold | 50 | 518 |
| 10 | K-3: Enzyme 6 hr hold | 50 | 459 |
| 11 | K-3: Enzyme 6 hr hold | 50 | 459 |
| 12 | I-F: Filtered | 50 | 729 |
| | lot# WRP34316 | | |
| 13 | I-F: Filtered | 50 | 729 |
| | lot# WRP34316 | | |
| 14 | — | — | — |
| 15 | High and Low Range | — | — |
| | Molecular Weight Standards | | |

TABLE 6
Total protein results as a percentage of sample weight.

| | Protein as a percentage |
|---|---|
| Sample | of sample weight |
| K-1: Enzyme 2 hr hold | 8.4% |
| K-2: Enzye 4 hr hold | 9.7% |
| K-3: Enzyme 6 hr hold | 10.9% |
| K-5: Raw material lot# HZN16003E | 4.5% |
| I-F: Filtered lot# WRP34316 | 6.9% |

The known standards are on the far left of FIG. 4A with select high molecular weight standards in track 1 and select low molecular weight standards in track 2. The buffer standard was run in track 3 and showed on bands or peaks indicating that the buffer carrier did not interfere with the protein/peptide stains in the other PAGE tracks. The starting protein material is shown in the heavy blue tracks in duplicate next to the standards in tracks 4 and 5 to provide a comparison of before and after the protease activity. The next tracks show the peptide fractions in duplicate which were held at 2 hours (tracks 6 & 7), 4 hours (tracks 8 & 9), and 6 hours (tracks 10 & 11) exposure time of protease enzyme activity until the protease enzyme was deactivated with 85° C. heat for 10 minutes. A second run at 2 hours of protease enzyme exposure time was performed and this sample was filtered through a paper filter. The PAGE result of the filtered peptides is shown in tracks 12 and 13. The peptide solution was filtered to see if it would impact on the PAGE band development. The PAGE did appear somewhat better defined by filtering the sample. Track 15 is a combination of both the high and low molecular weight standards again for reference.

The same gel track plate is shown on the PAGE BAND INDENTIFICATION IMAGE with the tracks marked for easier identification. These tracks can be used as reference to the peaks that are shown on the optical scans that are described herein.

The gel tracks are shown again in a different way through the use of an optical scanning device to provide a more detailed look at the gel bands (FIGS. 4B-4F). One scan of each one of the respective tracks was selected and provided to better show the peptide bands (note the gel plate tore through some of the tracks on both plates so the best scan of each duplicate plate was included here to eliminate the issue and slight distortion of the tears. Note the numbers at the top of the scan figures correspond to the more enriched bands on the gel plates. The molecular weight of the peptide and protein peaks are shown in log scale at the bottom of the scan figures for reference. Briefly, FIGS. 4B-F are scans showing the molecular weight distribution of the tracks from the FIG. 4A PAGE gel plate. FIG. 4B is Lane 4 Sample: K-5 Raw Material Lot #HZN16003E. FIG. 4C is Lane 6 Sample: K-1 Enzyme 2 hr hold. FIG. 4D is Lane 8 Sample: K-2 Enzyme 4 hr hold. FIG. 4E is Lane 11 Sample: K-3 Enzyme 6 hr hold. FIG. 4F is Lane 13 Sample: I-F Filtered Lot #WRP34316.

FIG. 4B is the scan of the untreated feed material from track 4. It was noted that the heavy bands (e.g., shown as peaks) in the high molecular weight regions were diminished in the protease-exposed sample tracks. It was noted that the relative height of peak 1 compared to the other peaks and there was a decrease in components below molecular weight from peak 1 to almost nothing at the 3,000 molecular weight mark. FIG. 4C is the scan of track 6 for the peptide solution exposed for 2 hours to the protease enzyme. It was noted that most of the proteins above the 20,000 molecular weight band were present in reduced amounts, while the amounts of lower molecular weight peptide peaks were higher relative to the large molecular weight peaks (indicating shorter chain peptide production). It was also noted that there was new material below peak 4 with a band now at peak 5 which did not exist in the untreated feed stock material (shown in FIG. 4B). These peak shifts were indicative of peptide production. FIG. 4D is track 8 scan and showed the starting protein solution after exposure to 4 hours of protease treatment. It was noted that there was more peptide absorbance at the lower molecular weight regions with some extra low molecular weight peaks forming compared to FIGS. 4B and 4C. The height of peak 5 which was missing in FIG. 4B was almost the same height as peak 4 in FIG. 4C. FIG. 4E shows the track 11 scan after 6 hours exposure to the protease enzyme treatment. It was noted that the relative heights of the lower molecular weight peaks enriched relative to the higher molecular weight peaks. Peaks 1, 2, and 3 were of similar height as peak 4 indicating continued production of lower molecular weight peptides with time. FIG. 4F shows the track 13 with the filtered 2 hour protease exposed protease enzyme treated solution. The filtration may have removed some particulate giving a slightly more defined PAGE scan. Ultrafiltration could be used to isolate the peptide chelant, select bands preferentially, and concentrate the peptides for further use in the chelation process described herein. From this data it is expected that protein broken down into lower molecular weight peptide fragments would give more molecules to grab and hold onto heavy metal ions for removal from the rice protein isolate mixture.

The results in FIG. 4C demonstrated that the K-1 rice protein hydrolyzed product (e.g., peptide chelator) contained at least a mix of peptides ranging from about 21 kD down to about 1,000 kD and with the pronounced bands in the solution ranging from about 21 kD to about 19 kD, about 16 kD to about 14 kD, about 13 kD to about 12.5 kD, about 11.5 kD to about 10.5 kD and about 4 kD to about 2 kD. The most abundant peptides (labeled as band 1, 2, and 3 in FIG. 4C) had a molecular weight of about 20.5 kD, about 15 kD, and about 12.7 kD, as shown. The results in FIG. 4D demonstrated that the K-2 rice protein hydrolyzed product (e.g., peptide chelator) contained at least bands in the solution ranging from about 21 kD to about 19 kD, about 16 kD to about 14 kD, about 13.5 kD to about 12.5 kD, about 11.5 kD to about 10.5 kD and about 4 kD to about 2 kD. The most abundant peptides (labeled as band 1, 2, and 3 in FIG. 4D) had a molecular weight of about 20.5 kD, about 15 kD, and about 12.7 kD, as shown. The results in FIG. 4E demonstrated that the K-3 rice protein hydrolyzed product (e.g., peptide chelator) contained at least bands in the solution ranging from about 21 kD to about 19 kD, about 16 kD to about 14 kD, about 13.5 kD to about 12.5 kD, about 11.5 kD to about 10.5 kD and about 4 kD to about 2 kD. The most abundant peptides (labeled as band 1, 2, 3, and 4 in FIG. 4E) had a molecular weight of about 20.5 kD, about 15 kD, about 12.7 kD, and about 11 kD, as shown.

### Example 5

The following is an example of testing that has been done to show the efficacy of utilizing activated charcoal on a protein/starch slurry to remove heavy metals. The capacity for 1) activated charcoal (“EXPT 1^{A}”) and 2) deionized water (“CONTROL^{a}”) to remove metals from rice flour is measured. The activated charcoal is selected to have a particular mesh size, in this case having a mesh size of 20-40 (˜800-420 μm). The metal levels of the rice flour prior to treatment and after exposure to the each of the heavy metal reducing agents in EXPT 1^{a} is measured and compared to the CONTROL^{a}. The solution pH was 5.3 which was the natural pH of the protein/starch slurry.

For each of the tests below, a bulk solution of is prepared by grinding rice to a mesh value of 50 (e.g., ˜330 μm). The rice flour powder is analyzed to determine its heavy metal (Arsenic: 200 ppb; Cadmium: 1200 ppb; Lead: 500 ppb; Mercury: 50 ppb). In general, for binding agent(s) (EXPT 1^{a}), or water with no binding agent (CONTROL^{a}), the following procedures are used. Briefly, 500 mL of deionized water is heated to 23° C. and stirred. To the water is added untreated rice flour (100 grams of rice flour contaminated with heavy metals). These samples are prepared for each of EXPT 1^{a} and the CONTROL^{a} (forming 2 mixtures in total). At that time, enough of heavy metal reducing agent (binder) to prepare a 2 wt % mixture of heavy metal reducing agent is added to each mixture. No heavy metal reducing agent was added to the CONTROL^{a} sample. The pH was allowed to be the natural pH of the protein/starch slurry which was 5.3 for the samples in EXPT 1 and the CONTROL—6 total samples.

The mixtures were agitated for 60 minutes at a temperature of 23° C. at which time each sample was filtered through a 45 mesh filter (e.g., ˜370 μm) to remove any binding agents present (e.g., for EXPT 1^{a} and CONTROL^{a}). The filter cake was washed twice with 50 mL aliquots of filtrate. At that time, to remove any soluble and/or small particle chelant, the filtrate is then centrifuged to separate the protein/starch slurry solids from the solvent (water). The solvent (water) supernatant was then decanted off and the protein/starch solids were resuspended in 2× weight waster and then centrifuged again. This process was repeated for a total of 4 rinse centrifuge decantations. The final centrifuged solids cakes are collected and analyzed for target heavy metals and compared with the heavy metals in the final solids cake for the CONTROL^{a}. The following provides prophetic results of this testing:

TABLE 7

| | Arsenic | Cadmium | Lead | Mercury |
|---|---|---|---|---|
| Sample | (ppb) | (ppb) | (ppb) | (ppb) |
| Starting | 200 | 1200 | 500 | 50 |
| CONTROL^{a} | 150 | 200 | 400 | 20 |
| EXPT 1^{a} | 109 | 175 | 4 | 14 |

### Example 6

The following is a prophetic example. The capacity for 1) activated charcoal (“EXPT^{b} 1”), 2) zeolite (“EXPT^{b} 2”), 3) a 50% by weight mixture of activated charcoal and zeolite (“EXPT^{b} 3”), 4) a mixture of activated charcoal and peptide chelator as prepared in Example 2 (“EXPT^{b} 4”), 5) a mixture of zeolite and peptide chelator as prepared in Example 2 (“EXPT^{b} 5”), or 6) deionized water (“CONTROL^{b}”) to remove metals from rice flour is measured. The activated charcoal and zeolite are selected to each have a particular mesh size, in this case having a mesh size of 30 (˜595 μm). The metal levels of the rice flour prior to treatment and after exposure to the each of the heavy metal reducing agents in EXPT^{b} 1-5 is measured and compared to the CONTROL^{b}. To test the ability of the heavy metal reducing agents of EXPT^{b} 1-5 and the CONTROL^{b} to remove heavy metals from a food product is then tested at various pH values is also tested.

For each of the tests below, a bulk solution of is prepared by grinding rice to a mesh value of 50 (e.g., ˜330 μm). The rice flour powder is analyzed to determine its heavy metal (Arsenic: 200 ppb; Cadmium: 1200 ppb; Lead: 500 ppb; Mercury: 50 ppb). In general, for binding agent(s) (EXPT^{b} 1-3), a binding agent and chelant mixture (EXPT^{b} 4-5), or water with no binding agent or chelant (CONTROL^{b}), the following procedures are used. Briefly, 500 mL of deionized water is heated to 50° C. and stirred. To the water is added untreated rice flour (100 grams of rice flour contaminated with heavy metals). These samples are prepared in triplicate for each of EXPT^{b} 1-5 and the CONTROL^{b} group (forming 18 mixtures in total; 3 for EXPT^{b} 1, 3 for EXPT^{b} 2, etc.). At that time, enough of heavy metal reducing agent (binder and/or chelant) to prepare a 2 wt % mixture of heavy metal reducing agent is added to each mixture. No heavy metal reducing agent was added to the three CONTROL^{b} samples. The pH is then adjusted to 3 for one sample in each group (EXPT^{b3} 1-5 and the CONTROL^{b3} —6 total samples), pH 6 for one sample in each group (EXPT^{b6} 1-5 and the CONTROL^{b6} —6 total samples) and at pH 9 (EXPT^{b9} 1-5 and the CONTROL⁹ —6 total samples). The pH of the solutions is adjusted using solutions of 10% by weight HCl or 10% by weight of concentrated 50% NaOH.

The mixtures are agitated for 15 minutes at a temperature of 70° C. at which time each sample is filtered through a 40 mesh filter (e.g., ˜420 μm) to remove any binding agents that is present (e.g., for EXPT^{b3} 1-5, EXPT^{b6} 1-5, EXPT^{b9} 1-5). The filter cake is washed twice with 50 mL aliquots of filtrate. At that time, to remove any soluble and/or small particle chelant, the filtrate is filtered again using a smaller filter pore size 60 mesh filter (e.g., 250 μm); in some embodiments, other filter sizes can be used including, for example a 0.1 μm filter or any other filter with a pore size sufficient to prevent the pass through of food product while allowing the chelant to travel through the filter. The filter cake (e.g., the treated food product) is washed twice with chilled water (e.g., 5° C.). The filter cake samples are then collected and the heavy metal content is measure. The following provides results of this prophetic testing:

TABLE 8

| | Arsenic | Cadmium | Lead | Mercury |
|---|---|---|---|---|
| Sample | (ppb) | (ppb) | (ppb) | (ppb) |
| Starting | 200 | 1200 | 500 | 50 |
| CONTROL^{b3} | 150 | 200 | 400 | 20 |
| CONTROL^{b6} | 155 | 250 | 400 | 20 |
| CONTROL^{b9} | 160 | 300 | 350 | 20 |
| EXPT^{b3} 1 | 105 | 140 | 4 | 14 |
| EXPT^{b6} 1 | 109 | 175 | 4 | 14 |
| EXPT^{b9} 1 | 112 | 210 | 3.5 | 14 |
| EXPT^{b3} 2 | 105 | 140 | 4 | 14 |
| EXPT^{b6} 2 | 109 | 175 | 4 | 14 |
| EXPT^{b9} 2 | 112 | 210 | 3.5 | 14 |
| EXPT^{b3} 3 | 105 | 140 | 4 | 14 |
| EXPT^{b6} 3 | 109 | 175 | 4 | 14 |
| EXPT^{b9} 3 | 112 | 210 | 3.5 | 14 |
| EXPT^{b3} 4 | 79 | 105 | 3 | 10 |
| EXPT^{b6} 4 | 82 | 131 | 3 | 10 |
| EXPT^{b9} 4 | 82 | 158 | 2.5 | 10 |
| EXPT^{b3} 5 | 79 | 105 | 3 | 10 |
| EXPT^{b6} 5 | 82 | 131 | 3 | 10 |
| EXPT^{b9} 5 | 82 | 158 | 2.5 | 10 |

### Example 7

The following is a prophetic example. The capacity for 1) a 50% by weight mixture of activated charcoal and peptide chelator (“EXPT^{c} 1”), 2) a 50% by weight mixture of zeolite and peptide chelator (“EXPT^{c} 2”), 3) a 50% by weight mixture of activated charcoal and citric acid (“EXPT^{c} 3”), 4) a 50% by weight mixture of zeolite and citric acid (“EXPT^{c} 4”), 5) a 50% by weight mixture of activated charcoal and EDTA (“EXPT^{c} 5”), or 6) deionized water (“CONTROL^{c}”) to remove metals from rice flour is measured. The activated charcoal and zeolite are selected to each have a particular mesh size, in this case having a mesh size of 30 (˜595 μm). The metal levels of the rice flour prior to treatment and after exposure to the each of the heavy metal reducing agents in EXPT^{c} 1-5 is measured and compared to the CONTROL^{c}.

For each of the tests below, a bulk solution of is prepared by grinding rice to a mesh value of 50 (e.g., ˜330 μm). The rice flour powder is analyzed to determine its heavy metal (Arsenic: 0.85 ppm; Cadmium: 1.20 ppm; Lead: 0.85 ppm; Mercury: 0.050 ppm). In general, for the binding agent and chelant mixture, or water with no binding agent or chelant (CONTROL^{c}), the following procedures are used. Briefly, 500 mL of deionized water chilled to 15-23° C. and stirred. To the water is added untreated rice flour (100 grams of rice flour contaminated with heavy metals). At that time, enough of heavy metal reducing agent (binder and chelant) to prepare a 0.2 wt % mixture of heavy metal reducing agent to total solution weight is added to each mixture. No heavy metal reducing agent was added to the CONTROL^{c} samples.

The mixtures are agitated for 15 minutes at a temperature of 70° C. at which time each sample is filtered through a 40 mesh filter (e.g., ˜420 μm) to remove any binding agents that is present (e.g., for EXPT^{c} 1-5). The filter cake is washed twice with 50 mL aliquots of filtrate. At that time, to remove any soluble and/or small particle chelant, the filtrate is filtered again using a smaller filter pore size 60 mesh filter (e.g., 250 μm); in some embodiments, other filter sizes can be used including, for example a 0.1 μm filter or any other filter with a pore size sufficient to prevent the pass through of food product while allowing the chelant to travel through the filter. The filter cake (e.g., the treated food product) is washed twice with chilled water (e.g., 5° C.). The filter cake samples are then collected and the heavy metal content is measure. The following provides results of this prophetic testing:

TABLE 9

| | Arsenic | Cadmium | Lead | Mercury |
|---|---|---|---|---|
| Sample | (ppm) | (ppm) | (ppm) | (ppm) |
| Starting | 0.85 | 1.2 | 0.85 | 0.050 |
| CONTROL^{c} | 0.80 | 0.9 | 0.65 | 0.020 |
| EXPT^{c} 1 | 0.05 | 0.01 | 0.001 | 0.002 |
| EXPT^{c} 2 | 0.07 | 0.02 | 0.002 | 0.006 |
| EXPT^{c} 3 | 0.06 | 0.01 | 0.001 | 0.002 |
| EXPT^{c} 4 | 0.04 | 0.01 | 0.001 | 0.004 |
| EXPT^{c} 5 | 0.05 | 0.01 | 0.002 | 0.002 |

The above description provides context and examples, but should not be interpreted to limit the scope of the inventions covered by the claims that follow in this specification or in any other application that claims priority to this specification. No single component or collection of components is essential or indispensable. For example, some embodiments may not include a fluid modifier. Any feature, structure, component, material, step, or method that is described and/or illustrated in any embodiment in this specification can be used with or instead of any feature, structure, component, material, step, or method that is described and/or illustrated in any other embodiment in this specification.

Several illustrative embodiments have been disclosed. Although this disclosure has been described in terms of certain illustrative embodiments and uses, other embodiments and other uses, including embodiments and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various embodiments. All possible combinations and sub-combinations of elements and components described herein are intended to be included in this disclosure. No single feature or group of features is necessary or indispensable.

In summary, various embodiments and examples of chelators and methods of reducing metals have been disclosed. This disclosure extends beyond the specifically disclosed embodiments and examples to other alternative embodiments and/or other uses of the embodiments, as well as to certain modifications and equivalents thereof. Moreover, this disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims.

1. (canceled)

2. A method for preparing an organic food product with reduced heavy metal content, the method comprising:
adding an organic certified or organic certifiable binding agent to an organic food product that contains a heavy metal;
allowing the binding agent to bind to the heavy metal; and
separating the binding agent from the food product by filtering the binding agent away from the food product to prepare the organic food product with reduced heavy metal content;
wherein the food product is not a whole grain product;
wherein the binding agent comprises charcoal or activated carbon.

3. The method of claim 1, further comprising adding a chelator to the organic food product.

4. The method of claim 2, wherein the organic certified or organic certifiable chelator is a peptide chelator, citric acid, or salts thereof.

5. The method of claim 2, wherein the food product is a macronutrient isolate.

6. The method of claim 4, wherein the macronutrient isolate is a carbohydrate isolate, a fat isolate, or a protein isolate.

7. The method of claim 4, wherein the macronutrient is derived from a plant.

8. (canceled)

9. The method of claim 2, wherein the food product is derived from plant materials such as white rice, brown rice, rice bran, flaxseed, coconut, pumpkin, hemp, pea, chia, lentil, fava, potato, sunflower, quinoa, amaranth, oat, wheat, or combinations thereof.

10. The method of claim 2, wherein the food product is a plant protein.

11. The method of claim 2, wherein the heavy metal is arsenic, cadmium, lead, mercury, or combinations thereof.

12.-14. (canceled)

15. The method of claim 2, wherein the binding agent comprises one or more of charcoal, an activated carbon, a zeolite, an alginate, and/or a clay.

16. The method of claim 2, wherein the chelator is a peptide chelator, wherein the peptide chelator is prepared by hydrolyzing an organic protein for organic food products and/or by hydrolyzing a non-organic protein for non-organic food products.

17. (canceled)

18. The method of claim 16, wherein the organic protein is derived from the same plant or animal as the food product and/or wherein the protein is derived from the same plant or animal food product that is non-organic for non-organic food product.

19. A composition comprising a plant protein isolate or concentrate comprising a heavy metal bound to one or more of an organic certified or organic certifiable binding agent and/or an organic certified or organic certifiable chelator; wherein the binding agent comprises charcoal.

20. The composition of claim 18, wherein the organic certified or organic certifiable chelator is a peptide chelator or citric acid.

21. The composition of claim 18, wherein the binding agent comprises one or more of charcoal, an activated carbon, a zeolite, an alginate, and/or a clay.

22. An intermediate in the production of a nutritional supplement, the intermediate comprising a plant protein isolate or concentrate comprising a heavy metal bound to one or more of an organic certified or organic certifiable binding agent and/or an organic certified or organic certifiable chelator; wherein the binding agent comprises charcoal.

23.-25. (canceled)
